(19) United States
(12) Patent Application Publication
(10) Pub. No.: US 2011/0126128 A1
(43) Pub. Date: May 26, 2011

(54) FUTURE INSIGHT MAPS AND ASSOCIATED TOOLS

(75) Inventors: BRUCE MCKENZIE, VINCENTIA (AU); JANE LORAND, SANTA ROSA, CA (US); BRIAN HAMLIN, OAKLAND, CA (US)

(73) Assignee: FUTURE INSIGHT MAPS, INC., SANTA ROSA, CA (US)

(21) Appl. No.: 12/890,523

(22) Filed: Sep. 24, 2010

Related U.S. Application Data
(60) Provisional application No. 61/246,504, filed on Sep. 28, 2009.

(51) Int. Cl. G06F 3/01

(52) U.S. Cl. 715/753

(57) ABSTRACT

A diverse group of participants using on one or more client machines is enabled to generate on a user interface their solicited responses about any set of two or more independent variables that underlie a complex issue. The two or more independent variables are applied against each other. A likely outcome is predicted, wherein an application resident on a server is configured to integrate the solicited responses from the participants. The results are displayed on the display of the client machines to enable the participants to view. The participants are to develop insights related to the complex issue based on reviewing the results.

### RELATED APPLICATIONS

This application claims the benefit of and priority to U.S. Provisional Application titled “Future Insight Maps and Associated Tools” filed on Sep. 28, 2009 having application Ser. No. 61/246,504.

### NOTICE OF COPYRIGHT

A portion of the disclosure of this patent document contains material that is subject to copyright protection. The copyright owner has no objection to the facsimile reproduction by anyone of the software engine and its modules, as it appears in the Patent and Trademark Office Patent file or records, but otherwise reserves all copyright rights whatsoever.

### FIELD OF THE INVENTION

Embodiments of the invention generally relate to group collaboration for effective management of complex issues (both present and future) facing organizations utilizing unique systemic methods, transparency and anonymity. More particularly, an aspect of the embodiment of the invention enables multi-method approaches in an integrated yet variable pattern to release the embedded, relevant knowledge of the participants, thus generating Future Insight Maps of Complex Issues.

### BACKGROUND

SWOT (Strengths, Weaknesses, Opportunities, and Threats)/Conventional Strategic Planning processes are not comprehensive and struggle to include people effectively across disciplines, departments, silos, and outside the organization. Cultural and hierarchical barriers to inclusion and candor block disclosure of crucial perspectives and impede comprehensive exploration of complex issues. SWOT and conventional strategic planning processes are also not generally automated in a computing environment.

### BRIEF DESCRIPTION OF THE DRAWINGS

The multiple drawings refer to the embodiments of the invention.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

FIG. 1 is an example computing environment that may be used with some embodiments of the invention;

FIG. 2 is an example network diagram illustrating a network environment that may be used, in accordance with some example embodiments;

FIG. 3A is a block diagram that illustrates the anticipatory tools, in accordance with some embodiments.

FIG. 3B is an example block diagram that illustrates the windtunneling tools, in accordance with some embodiments;

FIG. 4A is a flow diagram that illustrates an example of a windtunneling process, in accordance with some embodiments;

FIG. 4B is a flow diagram that illustrates another example of a windtunneling process, in accordance with some embodiments;

FIG. 5A is an example user interface that may be used by a participant to provide an event headline and comments about the event headline, in accordance with some embodiments;

FIG. 5B is an example user interface that may be used by a participant to categorize his/her future event according to major area of focus, in accordance with some embodiments;

FIG. 5C is an example table or map that illustrates the events/headlines provided by the participants, in accordance with some embodiments.

FIG. 6 is an example user interface that may be used by a participant to assess one or more events, in accordance with some embodiments;

FIG. 7A is an example user interface that displays an impact vs. probability graph based on assessments of the participants, in accordance with some embodiments;

FIG. 7B illustrates example outcome table of future events assessment from the participants, in accordance with some embodiments;

FIG. 8 is an example of a wind tunneling matrix user interface that may be used by a participant to review assessments by all the other participants about all the events that were rated in accordance with some embodiments;

FIG. 9A illustrates an example user interface that may be presented to a participant to enable the participant to provide observations and rationale, in accordance with some embodiments;

FIG. 9B is an example windtunneling matrix that illustrates an outcome of observations provided by the participants, in accordance with some embodiments;

FIG. 10A illustrates an example user interface that provides detail information about the observations recorded per strategy, in accordance with some embodiments;

FIG. 10B illustrates an example user interface that may be presented to a small group of participants to enable one of the participants to provide insights for resilience for the named strategy from the group work, in accordance with some embodiments;

FIG. 10C illustrates a similar user interface as illustrated in FIG. 10A except for the observations displayed are associated with a future event, in accordance with some embodiments;

FIG. 10D illustrates the compilation of all the insights for each strategy, in accordance with some embodiments;

FIG. 11 is a table that illustrates an example outcome of resilience and insurance, in accordance with some embodiments;

FIG. 12A is a diagram that illustrates an example of a conversation map, in accordance with some embodiments; should refer to 12A1 and 12A2

FIG. 12B is a diagram that illustrates examples of multiple conversations that are recorded in a conversation map, in accordance with some embodiments;

FIG. 12C is a diagram that illustrates examples of tracking threads of conversation to identify patterns, themes and emergent issues, in accordance with some embodiments.

FIG. 13A is a flow diagram that illustrates an example of a conversation insight mapping, in accordance with some embodiments;

FIG. 13B is a flow diagram that illustrates another example of a conversation insight mapping, in accordance with some embodiments;

FIGS. 14A1-14A2 illustrate example user interfaces that a participant may use to track observations, in accordance with some embodiments;

FIG. 14B illustrates the four components of learning narrative, as they are detailed by each participant sequentially each day, and then the learning is shared weekly or bi-weekly among all participants, in accordance with some embodiments;

FIG. 15 is a block diagram that illustrates an example learning narrative insight mapping, in accordance with some embodiments;

FIGS. 16A-C are example graphical representations of needs of functional units involved in a strategy, in accordance with some embodiments;

FIG. 17 is a block diagram that illustrates an example coherent insight mapping, in accordance with some embodiments;

FIG. 18A illustrates an example user interface for over-the-horizon insight matrix, in accordance with some embodiments;

FIG. 18B is a flow diagram that illustrates over-the-horizon insight mapping, in accordance with some embodiments;

FIG. 19 illustrates an example of an integration of the various insight mappings, in accordance with some embodiments.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### SUMMARY OF THE INVENTION

A computer assisted method of enabling and collecting knowledge and insights from a diverse group of users to effectively manage a complex issue. A computer-based user interface is used to present the complex issue on one or more client computers. The complex issue may be associated with two or more variables. The computer-based user interface enables the users to share and compare their knowledge and observations about the complex issue. Diverse results collected from the users are then presented to all users. All participants contribute to patterns and emergent insights based on reviewing subsets of the observations of their peers. Based on maps of the developed perspectives of risk/opportunity/innovation/insights provided by all participants, management effectiveness and organizational coherence are enhanced for complex issues.

### DETAILED DISCUSSION

For some example embodiments, methods, apparatuses, and systems are disclosed to enable decision makers to take advantage of knowledge and insight from a broad diverse group of participants to resolve issues. The methods, apparatuses, and systems enable the decision makers to focus on knowledge development and access. Knowledge and insights about certain issues are collected from the participants. The knowledge and insights may be based on the participants' own reflection of the issues and also based on other participants' reflection of the issues which supports cross-silo learning and collaboration. Different variables may affect the participants' knowledge, perspectives, and insights. The knowledge and insights received from the participants may enable the decision makers to assess strategies against plausible future events and to derive optimal options for managing the complex issues.

The methods, apparatuses, and systems enable establishing a qualitative database from the imaginations or observations of all the participants and enabling each of the participants to review the observations stored in the database. Each participant is able to rate the observations submitted by their peers. Each participant contributes their unique perspectives about how a given strategy will perform in the face of the changed conditions that a future event may create. Contributions by all of the participants are anonymous and transparent. Systemic and critical thinking skills are developed by all participants as they work through the processes. The methods, apparatuses, and systems enable multiple reflections by all participants on various elements of the qualitative databases. Each of the participants is able to generate insights and patterns from observations made by all participants. These uniquely-derived insights optimize the organization's management and leadership teams as they strive to guide their organizations among today's complex issues.

In the following description, numerous specific details are set forth, such as examples of specific routines, named components, connections, anticipatory design tools, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention.

### I/ Overview

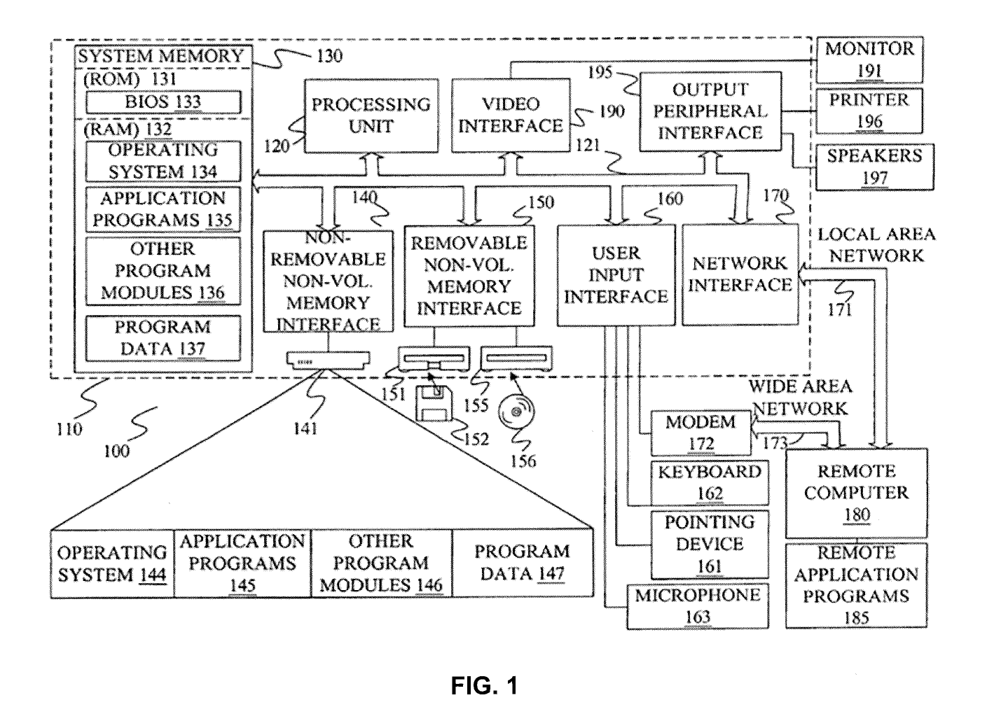

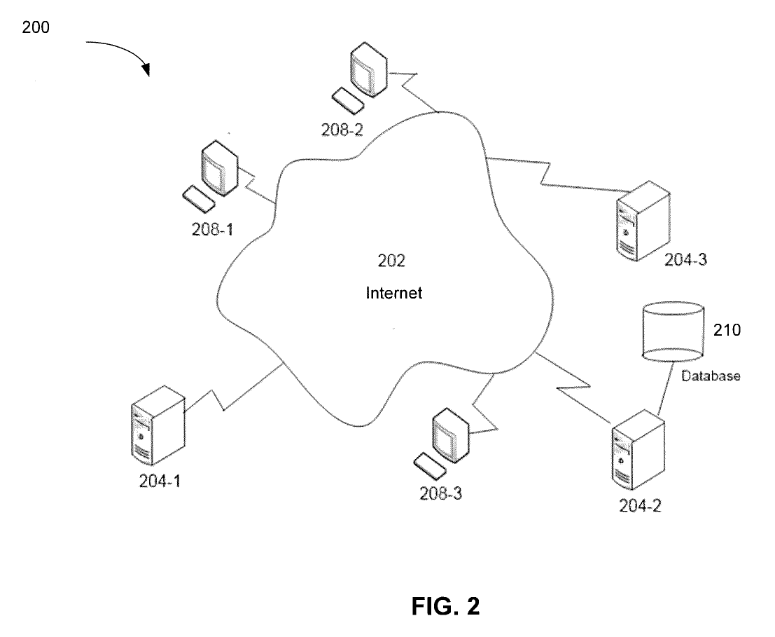

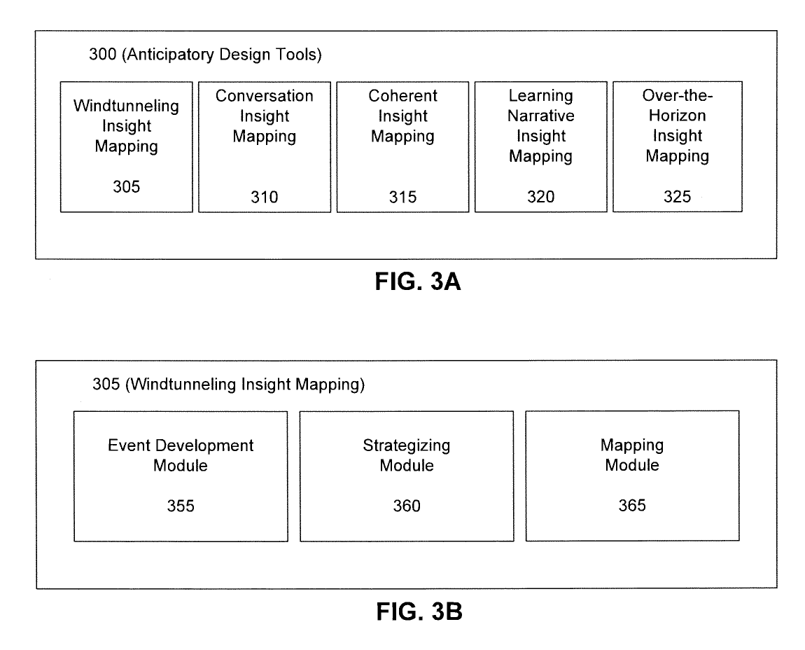

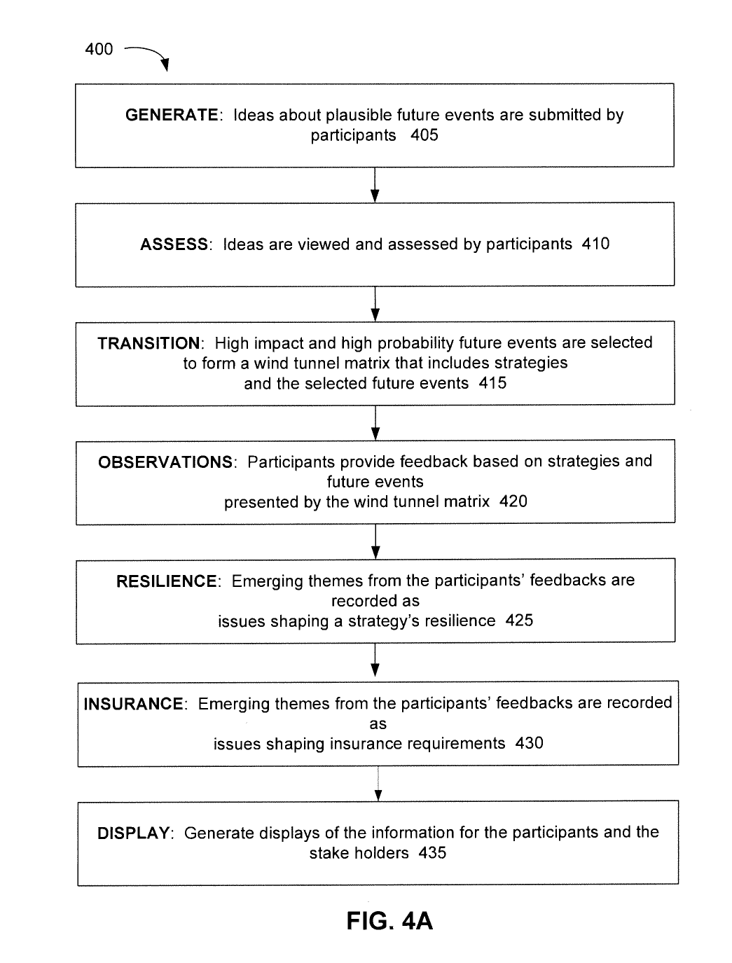

For some example embodiments, a set of anticipatory design tools is provided. The anticipatory design tools may be implemented using software, hardware or a combination of both. For example, when implemented as software applications, the anticipatory design tools may be stored in storage devices of computer systems. FIG. 3A is a block diagram that illustrates the anticipatory design tools, in accordance with some embodiments. The anticipatory design tools 300 may enable identifying plausible future events and identifying management options to mitigate risks, discover opportunities and build innovative capacity associated with those plausible future events. The anticipatory design tools 300 may reside in a stand-alone computer system, or they may be configured as web applications hosted by one or more server computers connected to a network, as described in FIG. 1 and FIG. 2.

When the anticipatory design tools 300 are implemented as web-based applications, the participants may use client computers and browser software to access the network, get connected to the server computers, and be able to provide their knowledge and insights. For some embodiments, the applications may be reside and execute partially on a client computer and partially hosted on a server computer.

The anticipatory design tools 300 may be used to unite the systemic activity of thinkers in traditionally distinct fields of expertise such as business and environment. The anticipatory design tools 300 may include codes scripted to generate capacity building that is resilient, future-focused and mitigates risk. The anticipatory design tools 300 are systemic practices to manage complex issues, and can be applied by themselves as stand-alone applications and/or with each other to guide the needs of each unique situation. These tools are highly useful for businesses, communities, and organizations facing uncertain futures as the tools provide crucial information that is unavailable through conventional methodologies. The anticipatory design tools 300 are comprised of several modules including:
Windtunneling Insight Mapping 305
Conversation Insight Mapping 310
Coherence Insight Mapping 315
Learning Narrative Insight Mapping 320, and
Over-the-horizon Insight Mapping 325.
   Each one of these modules will be described in more details in the following sections.

### II/ Computing Environment

FIG. 1 is an example computing environment that may be used with some embodiments of the invention. Computing environment 100 is only one example of a suitable computing environment and is not intended to suggest any limitations as to the scope of use or functionality of the embodiments of the present invention. Neither should the computing environment 100 be interpreted as having any dependency or requirement relating to any one or combination of components illustrated in FIG. 1.

Embodiments of the invention may be operational with general purpose or special purpose computer systems or configurations. Examples of well known computer systems that may be used include, but are not limited to, personal computers, server computers, hand-held or laptop devices, Tablets, Smart phones, Netbooks, multiprocessor systems, microprocessor-based systems, set top boxes, programmable consumer electronics, network PCs, minicomputers, mainframe computers, distributed computing environments that include any of the above systems or devices, and the like.

Embodiments of the present invention may be described in the general context of computer-executable instructions, such as program modules, being executed by a computer system. Generally, program modules include routines, programs, databases, objects, components, data structures, etc. that perform particular tasks or implement particular abstract data types. Those skilled in the art can implement the description and/or figures herein as computer-executable instructions, which can be embodied on any form of computer readable media discussed below.

Embodiments of the present invention may also be practiced in distributed computing environments where tasks are performed by remote processing devices that are linked through a communications network. In a distributed computing environment, program modules may be located in both local and remote computer storage media including memory storage devices.

Referring to FIG. 1, the computing environment 100 includes a general-purpose computer system 110. Components of the computer system 110 may include, but are not limited to, a processing unit 120 having one or more processing cores, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

Computer system 110 typically includes a variety of computer readable media. Computer readable media can be any available media that can be accessed by computer system 110 and includes both volatile and nonvolatile media, removable and non-removable media. By way of example, and not limitation, computer readable mediums uses include storage of information such as computer readable instructions, data structures, program modules or other data. Computer storage mediums include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other transport mechanism and includes any information delivery media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer system 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer system 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer system 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. The operating system 144, the application programs 145, the other program modules 146, and the program data 147 are given different numeric identification here to illustrate that, at a minimum, they are different copies.

A participant may enter commands and information into the computer system 110 through input devices such as a keyboard 162, a microphone 163, and a pointing device 161, such as a mouse, trackball or touch pad. Other input devices (not shown) may include a joystick, game pad, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer system 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer system 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer system 110 is connected to the LAN 171 through a network interface or adapter 170. When used in a WAN networking environment, the computer system 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer system 110, or portions thereof, may be stored in a remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that some embodiments of the present invention may be carried out on a computer system such as that described with respect to FIG. 1. However, some embodiments of the present invention may be carried out on a server, a computer devoted to message handling, handheld devices, or on a distributed system in which different portions of the present design may be carried out on different parts of the distributed computing system.

Another device that may be coupled to the system bus 121 is a power supply such as a battery or a Direct Current (DC) power supply) and Alternating Current (AC) adapter circuit. The DC power supply may be a battery, a fuel cell, or similar DC power source needs to be recharged on a periodic basis. The communication module (or modem) 172 may employ a Wireless Application Protocol to establish a wireless communication channel. The communication module 172 may implement a wireless networking standard such as Institute of Electrical and Electronics Engineers (IEEE) 802.11 standard, IEEE std. 802.11-1999, published by IEEE in 1999.

Examples of mobile computing devices may be a laptop computer, a tablet computer, Netbook, cell phone, a personal digital assistant, or other similar device with on board processing power and wireless communications ability that is powered by a Direct Current (DC) power source that supplies DC voltage to the mobile device and that is solely within the mobile computing device and needs to be recharged on a periodic basis, such as a fuel cell or a battery.

### III/ Network Environment

FIG. 2 is an example network diagram illustrating a network environment that may be used, in accordance with some example embodiments. Network environment 200 has a network 202 that connects with server computers 204-1 through 204-3, and client computers 208-1 through 208-3. As illustrated, several server computers 204-1 to 204-3 and several client computers 208-1 to 208-3 are connected to and communicate with one another via the network 202, which may be, for example, an on-chip communication network. Note that alternatively the network 202 might be or include one or more of: inter-chip communications, an optical network, the Internet, a Local Area Network (LAN), Wide Area Network (WAN), satellite link, fiber network, cable network, or a combination of these and/or others. Note that the number of client computers and server computers illustrated in FIG. 2 are used as examples only and is not meant to be restrictive.

The server computers 204-1 to 204-3 may represent, for example: a master device on a chip; a server system; an intellectual property core, such as a microprocessor, communications interface, etc.; a disk storage system; and/or computing resources. Likewise, the client computers 208-1 to 208-3 may have computing, storage, and viewing capabilities. The method and apparatus described herein may be applied to essentially any type of communicating means or device whether local or remote, such as a LAN, a WAN, a system bus, on-chip bus, etc.

It is to be further appreciated that the use of the term client computer and server computer is for clarity in specifying who initiates a communication (the client) and who responds (the server). No hierarchy is implied unless explicitly stated. Both functions may be in a single communicating device, in which case the client-server and server-client relationship may be viewed as peer-to-peer. Thus, if two devices such as the client computer 208-1 and the server computer 204-1 can both initiate and respond to communications, their communication may be viewed as peer-to-peer. Likewise, communications between the server computers 204-1 and, 204-2 and client computers 208-1 and 208-2 may be viewed as peer to peer if each such communicating device is capable of initiation and response to communication.

FIG. 2 also illustrates an embodiment of a server computer to display the application on a portion of a media space, such as a web page, a profile page on a social network site, etc. The application may be embedded into a third party's media space, such as an HTML web page, a page of a social network platform, etc. The application when executed on a server 204-1 causes the server 204-1 to display windows and user interface screens on a portion of a media space such as a web page. A participant from a client machine 208-1 may interact with the page that contains the embedded application, and then supply input to the query/fields and/or service presented by a user interface of the application. The web page may be served by a web server 204-1 on any HTML or wireless access protocol (WAP) enabled client computer 208-1 or any equivalent thereof such as a mobile device or personal computer. The client computer 208-1 may include browser software (e.g., Firefox) to access the web-based anticipatory design tools hosted by one or more of the server computers 204-1 to 204-3.

For some example embodiments, the anticipatory design tools 300 may include codes scripted to present fields and icons to take details of desired information. The anticipatory design tools 300 may be implemented as a web application hosted on the server computer 204-1 and served to the browser of client computers 208-1 and 208-2. The anticipatory design tools 300 may then serve web pages that allow a participant to use the client computer 208-1 to provide personal knowledge and insights. For some example embodiments, database 210 may be used to store information provided by the participants and other related information. The database 210 may be associated with a database server such as, for example, the server computer 204-2.

### IV/ Windtunneling Insight Mapping

Effective planning requires anticipation of changing conditions in the present and the future. Windtunneling engages diverse participants quickly and limits the withholding of information that typically occurs in hierarchical processes. Literally hundreds of individuals in an organization can inform the planning processes of an organization with minimal time commitment, travel, and related costs. Given the complex issues facing organizations in today's environment, multiple and diverse perspectives are essential to illuminate the risks and opportunities. Yet, typically, the organization tasks a handful of individuals with the planning responsibility of the organization, and these limited perspectives fail to reveal the true risks and opportunities that exists that could benefit the growth and health of the organization.

Windtunneling enables an organization to cost-effectively engage the experience, wisdom, unique networks and perspectives of diverse members of their staff/stakeholders. Strategic planning can incorporate the views of hundreds of highly educated and informed individuals, and thus expand the scope of what is possible, in terms of strategies and expand the organization's insights as to the effectiveness of current operations and strategies. Thus, before an organization invests resources in new strategies, they can secure the counsel, perspectives, and buy-in to build confidence and assurance that the strategies have a high likelihood of success. Similarly, parallel windtunneling projects can be underway testing current strategies and operations, informing the entire strategic planning initiatives of the organization. This enables the organization to devise a comprehensive plan that captures the best of what is currently operational and the best of innovative new ideas, based on the diverse perspectives required when working with complex issues. It should be noted that the term “event” and the phrase “future events” may be used interchangeably herein to refer to an event that has not occurred.

FIG. 3B is an example block diagram that illustrates the windtunneling modules, in accordance with some embodiments. The windtunneling insight mapping component 305 itself may include a set of modules (referred to herein as windtunneling modules) to enable an organization or community to examine its resilience in the face of future uncertainty through generating a set of logical actions to mitigate risk against a set of plausible future events and possible business scenarios. The windtunneling modules may be implemented in software, hardware or a combination of both. Referring to FIG. 3B, the windtunneling modules may include event development module 355, strategizing module 360, and mapping module 365.

The windtunneling modules 355-365 may allow an organization to identify activities that will enhance its resilience and provide insurance against risk associated with a variety of complex scenarios. For some embodiments, a diverse group of participants is gathered and considers the impact on the group's products and organization of various environmental/economic/political/economic, etc. changes. Control of these changes lies outside the group, but the group will be impacted by them. For example, the windtunneling modules 355-365 may be configured to receive input information and supply one more user interfaces to convey generated output. The output may enable:
Revealing areas of greatest risk to ongoing performance;
Identifying of products, services, and ways of meeting important needs that are prime for innovative activity;
Demonstrating where warning indicators need to be designed and implemented; and
Recommending direction and priorities to enhance resilience of a community or organization's strategies and programs.

The windtunneling modules 355-365 utilize diversity, candor, and imagination in a disciplined, virtual process to test and thus be able to enhance the long-term performance of multiple strategies, operations, and activities that are current or planned. The windtunneling modules 355-365 enable each strategy to be tested against a broad range of plausible futures or other changes that may disrupt the current operating environment, thus capitalizing on the embedded knowledge of the participants. The windtunneling modules 355-365 are based on systemic methodologies, complexity science, and anticipatory design science.

The windtunneling modules 355-365 are configured (e.g., scripted in software code) to perform various operations to achieve certain goals, including:
collecting, collating and displaying multi-disciplinary inputs on a single coherent database map;
mapping of multiple perspectives to enable identification of unknown relationships among variables in a complex problem;
reducing time required for strategic risk assessment;
providing enhanced comprehensiveness of the approach to risk identification, assessment, and management;
enabling heightened engagement of diverse stakeholders, thus raising stakeholder empowerment and culture change with minimal burdensome time/logistical support;
generating multiple options to improve performance within a complex issue;
raising participants' understanding of the complexity of the issue;
supporting managers to proactively take up complex issues;
enabling participants from multiple levels or departments of a large organization to collaborate more effectively to address complex issues that impact the whole organization;
encouraging each participant to imagine into a manageable “frame” of the future, and share insights.
encouraging all participants to identify patterns in the diverse responses, capitalizing on the diversity of life experiences and position within the organization;
enabling participants to work with escalating confidence relative to future consequences of current decisions;
giving the capacity to capture diverse knowledge about complex issues in a meaningful manner in a short time frame providing financial savings on current costs and enhanced confidence in decision making data;
accelerating building of multidiscipline “communities of practice” across an organization's diverse stakeholder groups;
reducing uncertainty in decision-making, building intellectual capital in the organization, and changing the culture to be more deliberative, reducing risk;
providing fore-sighting management, complex issue management, and staff competence development and assessment;
Provide enhanced access to an organization's or community's intellectual capital;
Enhance an organization's or community's social capital;
and many other features and functions described herein.
   It may be noted that, as discussed in FIGS. 1 and 2, the windtunneling modules 355-365 may be resident on desktop and mobile computers and computing devices, as well as implemented in a web-based client-server environment, as well as in a local area client-server environment.

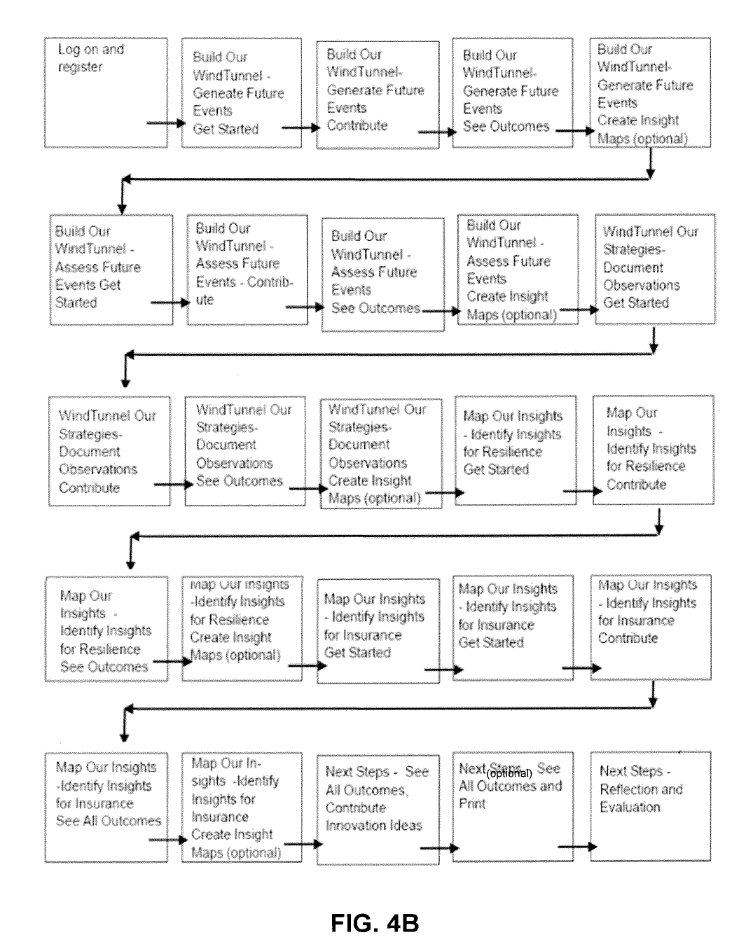

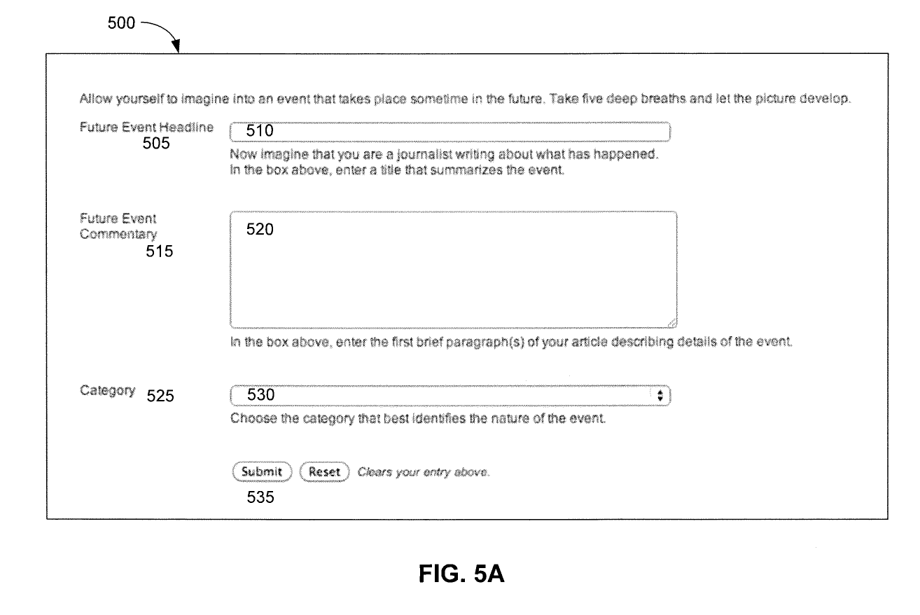

The windtunneling modules 355-365 may be scripted as web-based software applications and may present screens to the participants to lead them through a windtunneling insight mapping (described in FIG. 4A). There may be tutorial screens on each web page to help the participants grasp what it is, exactly, that they are being asked to do. Voiceovers may be supported to direct the participants through the windtunneling insight mapping. Once a participant has gone through the process, it is self-explanatory and easy to use.

The windtunneling insight mapping enables groups of participants of various sizes (e.g., 15 or more) to engage in a set of activities and operations within each activity that yields a “rich picture” of the multiple facets of the risk (many of which had yet to be identified). A “rich picture” is a term of art in systemic methods that reflects multiple perspectives of multiple aspects of a complex issue which is posing risk or opportunity to the specific organization/industry/region/nation/etc. Through a progression of inputs, large numbers of participants from various silos and levels of an organization or industry begin by imagining future events, each of which represents a constellation of changed conditions that have preceded it, conditions that accompany it, and changed conditions that are likely to proceed from it. Each condition poses a possible risk to the strategy (or strategies) of the organization. All of the participants then rate a selected, diverse group of these future events based on the impact it is likely to have on the designated population/group and the probability of it happening within a given time frame. For example, a designated population may be an organization. This creates a statistical display of what all the participants think of the scope and likelihood of a designated event and its risks are likely to be. From this information, all of the participants are asked to share their observations about a given strategy's performance under the change conditions of a future event. The participants also provide rationale for their observations. This enables the organization to have a highly informed and diverse database of the specific risks and possible resilience of multiple strategies (e.g., ten), testing each strategy against many future events (e.g., ten) and the changed conditions that accompany each event. All information is made available to the participants so that they have a much more highly informed picture of the risks and opportunities perceived by their fellow-participants. The strategy or strategies may be provided by the administrator.

The participants then enter into a process of clustering/patterning/developing emergent ideas about each specific strategy in order to generate ideas to mitigate the risk by redesigning the strategy to be more resilient should changed conditions actually occur. Thus, with the windtunneling insight mapping, a large number of participants can generate rich pictures of risks facing the organization's strategies. From these rich pictures, all of the participants may be able to assess impact and probability for a selected group of diverse future events (and the changed conditions that accompany such events). The participants make observations with rationale about their unique understanding of how each strategy designated by the organization would perform should a given event actually happen. The observations and rationale are stored and presented to all of the participants so that the learning by the participants about the embedded knowledge released by the organization's participants is extensive. For risk mitigation, the observation and rationale activities enable the participants to then work in systemic ways to identify patterns and emergent ideas about how to redesign the strategies under consideration to be more resilient under diverse changed conditions. In addition, in a parallel and subsequent the participants look at the organization as a whole and assess the risks and opportunities should any given event actually occur. They generate mitigation/insurance/innovation activities that the organization could take in the present to mitigate risks from uncertainty in the future.

In addition, there are risks in the present from the sheer complexity of variables influencing complex issues facing the organization. The windtunneling insight mapping enables the participants to identify these risks and emergent ideas that the organization can use to find new ways to approach the current risks. The organization can also use the results to find current mitigation opportunities to better manage the present risks due to variables outside of the control of the organization. It may be noted that the future events are used here as examples; other independent variables may also be used. For example, the independent variables may include industry challenges, vocational opportunities, etc. For example, the participants may be a group of students and the goal of the process is to determine how a certain variable may impact the students in the future.

FIG. 4A is a flow diagram that illustrates an example of a windtunneling process, in accordance with some embodiments. Windtunneling insight mapping 400 may engage a large number of participants, from within the organization and from stakeholders of the organization in exploring uncertain, complex issues facing the organization. In the windtunneling insight mapping, the participants are asked to imagine, assess, develop inferences and document observations, and provide rationale. They are also asked to engage in the systemic practice of “clustering, developing patterns and emergent ideas” from vast pools of ideas. The focus is reviewing and testing the strategies and operations of an organization, and at each point, the participants have the opportunity of entering into the process ideas for innovation that can be seen by all of the participants.

In going through the windtunneling insight mapping 400, a set of events are set up for consideration by all of the participants. They make observations about how each of a set of strategies/operations would be likely to perform under the changed conditions of each event. Thus a matrix multiple cells/frames may be considered by each of the participants individually. Their observations and rationale create a qualitative database that is open for consideration by all of the other participants. Each participant interprets each future event uniquely, thus each sees different risks and opportunities based on his/her experience, position in the organization, background, etc. Each participant reveals unique responses to uniquely-imagined change conditions, and how a strategy would likely fare under those conditions. Small groups of participants then collaborate to develop patterns and emergent ideas for how to improve the strategies/operations to improve performance under a variety of changed future conditions. This reflects the power of diversity in the windtunneling insight mapping 400 where the participants are sharing perspectives of uniquely developed scenarios and how the changed conditions will influence the organization's strategies and overall capacity to thrive and avoid catastrophic loss.

It may be noted that the scenarios considered in the windtunneling insight mapping 400 may not be highly specific or designed by experts. Rather than detailed scenarios, the windtunneling insight mapping 400 opens up, for the consideration and imagination of all the participants, diverse interpretations of the changed conditions that would be actualized by an imagined future event. The participants generate these events, and then rate them for probability and impact. The events are merely indicators of a set of imagined change conditions whereby each participant is actually testing strategies against a unique scenario, thus revealing more diversity and possibilities. In addition, the collaboration of the participants enable them to reflect on the ideas of all other participants, thus building the insight base for the organization, and promoting the emergence of ideas that can enable the redesign of strategies so that they are more resilient and build in “insurance” against catastrophic loss, should a given set of changed conditions (or one like it) actually come about. It should also be noted that the contributions by the participants are anonymous. Anonymity promotes candor and enables the organization to benefit fully from all of the perspectives of multiple, diverse participants. This diversity of perspectives is essential for effective systemic work.

To apply the windtunneling insight mapping 400, organization plans/strategies (or the ideas for which insights are being searched) may need to be transformed from using traditional pen and paper problem solving approaches into allowing the participants to use the computerized windtunneling insight mapping 400. This enables bringing a consistent approach to the participants for their considerations. Operations performed in blocks 405-415 are designed to enable the participants to generate and assess the impact/probability of future events—forming a first set of maps. Operations performed in blocks 420-430 are designed to enable the participants to imagine outcomes, explore patterns, and form adaptive responses—forming a second set of maps. The windtunneling insight mapping 400 may be initiated and managed by an administrator.

When applying the windtunneling insight mapping 400 to a project, a group of participants may be led through the entire process, including the operations performed in blocks 405-435. Alternatively, the group of participants may only need to participate in the operations associated with the blocks 405-415 or the operations associated with the blocks 420-435, based on the administrator's choice.

At any point of the windtunneling insight mapping 400, the participants can click a button and contribute related or unrelated ideas for innovation reporting on, for example, “What is the innovation idea?” “How does it work?” and “Why is it important to the organization.” The contributions are then stored in the database and be viewable when the participants select an option such as, for example, “See All Outcomes”. Thus, the participants who may have worked for years for the organization, and now have the opportunity to share ideas for innovations that may or may not be directly related to the strategies/operations being tested. There may be many ideas for innovation within the organization. However, because of typical organization hierarchy, gate keeping, communication patterns, culture, and tradition, these ideas remain dormant to the disadvantage of the organization. For some embodiments, one or more of the user interfaces associated with the different insight mappings may include a navigation bar to allow the participants to submit innovative ideas/insights.

The windtunneling insight mapping 400 provides the participants the opportunity to share their ideas with all of the other participants. In addition, as each participants reviews the idea for innovation generated by other participants, they may have new ideas and can enter them, refining and further developing the intellectual capital of the organization and putting it to use to capture innovative ideas that are set off by the thinking activities in the process. For some embodiments, the windtunneling insight mapping 400 enables the leaders of the organization to identify strategies that are resilient to changes and to identify insurance actions when a selected future event or something like it occurs if at all.

The windtunneling insight mapping 400 may start at block 405 where all of the participants can submit imagined ideas that they have about a plausible future events. There may be provisions for the ideas to be submitted under different category headings. Block 405 can generally be associated with the generate operation. After the completion of the operations in block 405, there is a pool of categorized input (e.g., events and commentary) offered by the participants. For example, each headline/title may be assigned an identification (ID) number, and the pool may be presented as a list of headlines along with their categories and ID number. The participants may re-order the list based on the categories (using alphabetic order) or based on the ID number (using numeric order). For some embodiments, there may be a library of professionally-developed plausible future events as well as a section in which administrators of organizations may generate their own imagined future events. The events may be categorized based on the purpose of the overall activity's goals. In general, the goals set up by the administrator, the independent variables and the categories are all synchronized for optimal relevance. Each of the participants may imagine or perform intuitive thinking about a situation or prompt, and generate a headline or title for their thoughts, as well as a commentary, expanding the thinking about the headline or title. The participants also evaluate an event's impact on an issue and the probability of it occurring, with context of impact and timeframe of occurrence being set by an administrator.

At block 410, the submitted events can be viewed and assessed by all of the participants. The participants review all of their input, study and reflect on the diversity and range of imaginations and thinking of the other participants. The participants may also study the statistical displays of the assessments of the other participants (e.g., their colleagues), and learn the depth and scope of the other participants' perspectives. Block 410 can generally be associated with the assess operation.

At block 415, the administrator may narrow the pool based on a set of one or more criteria. A representative sampling of the pool of input may then be identified by the administrator. For example, the administrator may select the future events that have high impact and high probability, high standard deviation, and diverse categories ensuring diversity of the changed conditions. These selected events may then be entered into a windtunneling matrix, and strategies can then be tested within the matrix. The matrix includes the organization plans/strategies (or ideas or situations where reviews are needed) set up vertically, and a subset of the independent variables (e.g., future events, industry challenges, significant ideas, etc.) set up horizontally. Block 415 can generally be associated with the transition operation.

At block 420, the participants consider each cell of the windtunneling matrix and provide their feedbacks/responses to the question along the line of “How will this strategy behave in situation created by this future event?” Each cell (or frame) of the windtunneling matrix is selected by the participants in order to document their observations about the performance, significance or impact of the two intersecting vertical and horizontal values. A searchable relational database (e.g., database 210) may be used to store the participants' observations by cell. Each entry is unique and based on the individual participant's interpretation of the intersection of the sets of variables. With each cell, the participants contribute their rationale for their observations. The participants may contribute multiple observations in each separate cells/frames. Block 420 can generally be associated with the apply operation.

The operations performed in block 425 require that each participant considers all of the observations which were made about one of the strategies and provide his/her insight. Once all of the insights for a strategy are recorded, the operations repeat with the next strategy. This is repeated for all of the strategies until all of the observations for all of the strategies are considered. The participants can review the information in each cell, learn about the scope and depth of the other participants' knowledge, their insight and unique experience that inspire their observations. Each strategy, challenge or idea may be displayed along with a row of observations from the horizontal axis. The inputs for the row may be organized, and small groups of participants may review just that particular row seeking insights to enable improvement in the strategy, plan, thinking, depth, and understanding about the strategy, challenge or idea. The results are then clustered by small groups of participants, identifying emergent themes and risks and opportunities for resilience. Emergent themes that a participant identifies from all of the responses (strength and weakness) are recorded as issues shaping the strategy, challenge or idea's resilience. The results are stored in the searchable relational database and may be available for all of the participants. For some embodiments, the emergent themes, patterns and areas of emphasis for all observations may be identified by grouping or clustering related or similar observations. Reviewing and clustering the observations by strategy allows the participants to see patterns and themes and possibly omissions that have not been identified before.

Specific insights for “resilience for strategies” or “significance of the ideas” may be captured in the outputs to support leaders in the organization and all the participants. In addition, at each point, the participants may have an opportunity to add ideas for innovation, and these ideas may also be captured in the insight maps presented to the organization's leaders and all the participants. For example, an innovation submission button may be displayed in an area of a user interface to allow a participant to click, describe and submit ideas for innovation. The facilitators/administrators of the project may work with the organization's leaders to create maps and displays of the insights derived from the above described techniques. The participants may review the insights generated in block 425 and add any insights that may occur to them. For each insight, the participants contribute insights and rationale for their observations. Again, the participants may contribute multiple insights. Specific insights such as, for example, “resilience for strategies” or “significance of the ideas” may be stored and made available to the participants. The goal is to come up with insights that will enable an organization to work with a specific strategy to make it more resilient to the changing conditions. Block 425 can generally be associated with the resilience operation.

At block 430, all the entries from the participants to a future event can be viewed. The operations performed in block 430 require that each participant consider all of the observations which were made about one of the future events. Once all of the insights for an event are recorded, the operations repeat with the next event. This is repeated for all of the events until all of the observations for all of the events are considered. Each future event, challenge, or relevant variable may be displayed along with a column in observations along the vertical axis. The inputs for the entire column are organized, and small groups of participants review just that row seeking insights to enable improvement in the action or thinking depth and understanding and knowledge about the organization's multiple plans, strategies, or ideas. The column's inputs are then clustered for emergent themes, risks, and opportunities for anticipatory design and entered into the database to be available for all of the participants. Block 430 can generally be associated with the insurance operation.

At block 435, the information stored in the database is displayed to the participants and the stake holders. The participants may review the insights generated in block 430 and add any additional insights that may occur to them. Emergent themes that a participant identifies from all of the responses (strength or weakness) are stored in the database as issues shaping insurance requirements. The goal is to come up with insights that will enable an organization to anticipate and plan for how it could optimize its position should that event, or an event like it, will occur.

The windtunneling insight mapping 400 may be applicable in multiple disciplines (e.g. psychology, engineering, management, etc). Maps that are generated using the windtunneling insight mapping 400 may include data maps that are displayed in a coherent single database for comparative assessment and application. The windtunneling insight mapping 400 eliminates location limitations over any paper and pencil use of similar methods. Currently, there is no other windtunneling process that has multiple activities and engagement of diverse participants, in an online environment, that facilitates such rich pictures of the future, and such effective insights into a wide array of improvements. The windtunneling insight mapping 400 builds capacities among entire organizations to “live into the future,” enhances competence, risk-averse behavior, masquerading, and over-dependence on outside experts who provide “futuring” or “scenario-based” activities.

The windtunneling insight mapping 400 invites and displays a wide range of disparate information, from diverse participants in such a way that the map facilitates the emergence of patterns and new ideas that relate back to and inform strategies, operations and activities that an organization seek to explore. The plurality of participants, strategies, interpretations, and plausible futures displayed in the mapping process facilitates imaginative responses that are further assembled to create more opportunities for innovative thought and product improvement. The windtunneling insight mapping 400 supports candor and “truth telling” in organizations where such behavior is politically dangerous. The anonymous and quick pace of contributions enables people to raise “politically incorrect” issues that have been chronically avoided by the organization. The windtunneling insight mapping 400 enables the power of people to tell the truth and discuss the “white elephants” in the room. FIG. 4B is a flow diagram that illustrates another example of a windtunneling process, in accordance with some embodiments. Each of the blocks in FIG. 4B includes description of its associated operations.

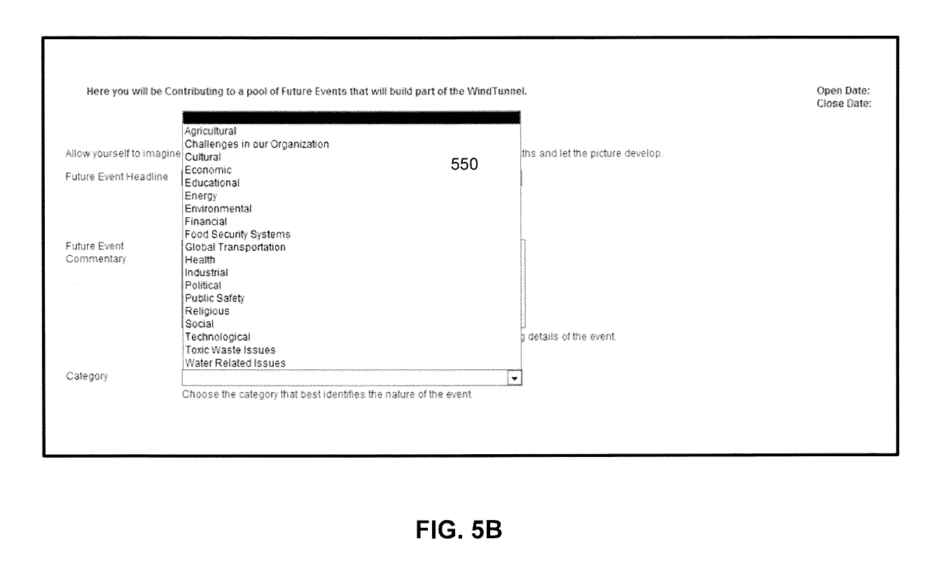

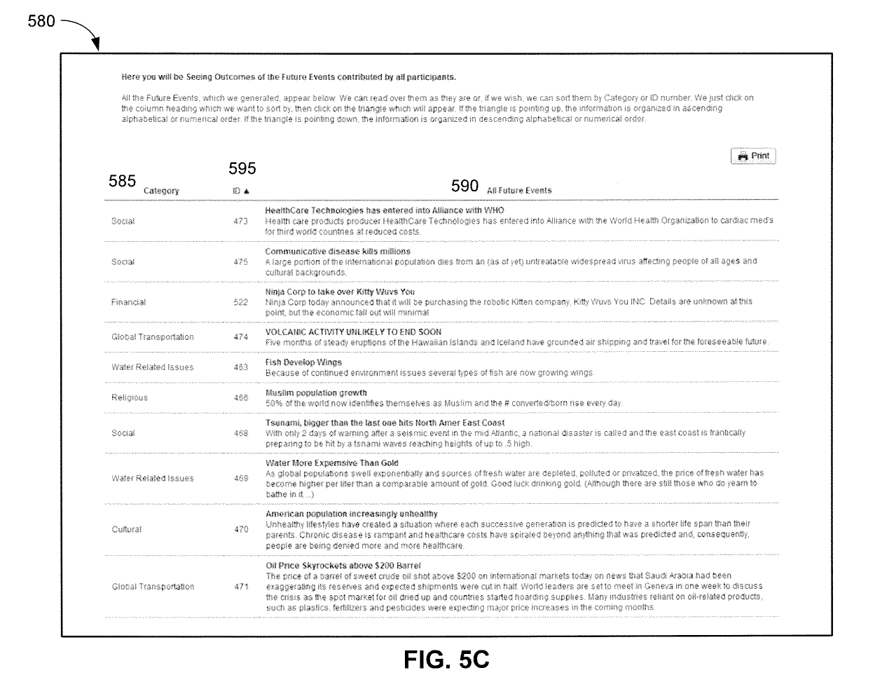

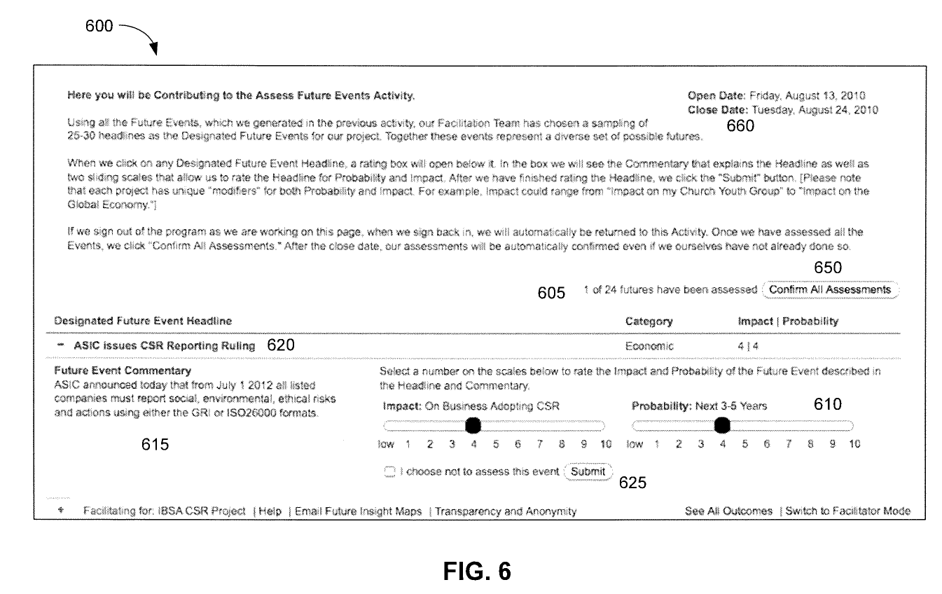

FIG. 5A is an example user interface that may be used by a participant to provide an event headline and comments, in accordance with some embodiments. An administrator may need to set the parameters in order to clarify what type of imagined change is being asked of the participants so that the information received from the participants may be more consistent. User interface 500 includes event headline section 505, commentary section 515 and category section 525. Participants are invited to generate plausible future events by entering them into event headline input area 510. The elaboration is entered into the detail of event input area 520. The participants may categorize their events in a category using category selector box 530. For example, the categories may be economic, political, social, technical, etc. The submit button 535 may then be used to submit the participants' input. FIG. 5B illustrates example categories that may be selected for the events/headlines entered by the participants. Category window 550 may be displayed to enable the participants to select an appropriate category. The categories may have been set by an administrator.

FIG. 5C is an example table or map that illustrates the events/headlines provided by the participants, in accordance with some embodiments. Map 580 may be considered an outcome of the event development operations. The map 580 may include a list of all future events 590, a list of categories 585 that each of the events is placed under, and a list of ID number 595 that is generated for each event/headline. The map 580 may be viewed by all of the participants and may be printed to be reviewed offline. As described above with FIG. 4A, the order of the categories 585 and the order of the ID number 595 may be re-arranged alphabetically by category or numerically depending on what the participants prefer to view.

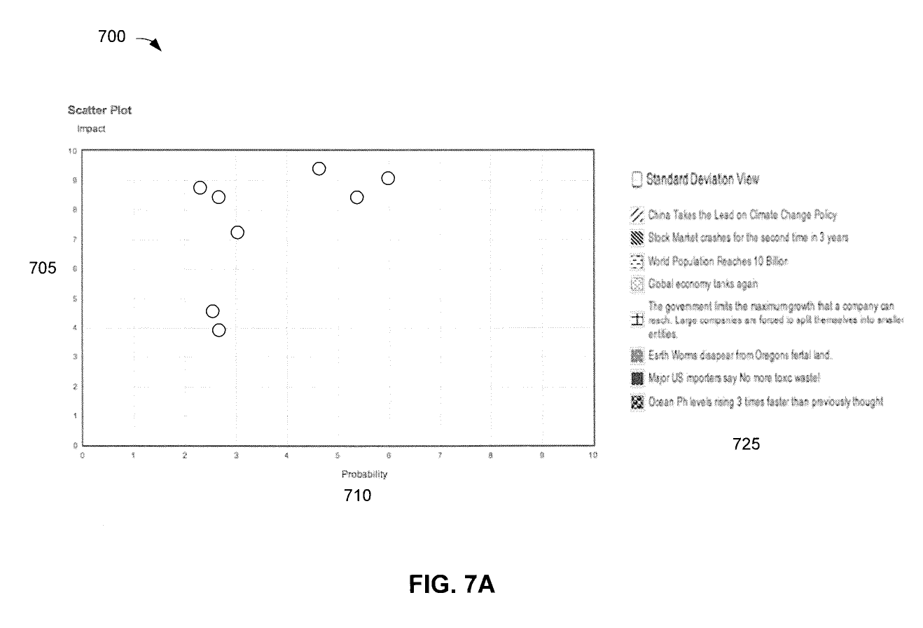

FIG. 6 is an example user interface that may be used by a participant to assess one or more events, in accordance with some embodiments. User interface 600 includes event identifying section 605, rating section 610, comment section 615, and event headline section 620. Each of the participants may review a certain number of events to provide their assessments of the events. A predetermined number of events (e.g., 20) may be set by the administrator for each participant to assess. The administrator may also select the events based on a wide array of set conditions. For each event, the participants determine their assessment of the probability/impact of that event, as illustrated in the rating section 610. A participant may elect not to rate an event. Respecting the participants experience of the contextualization of the rating process, a participant may be able to revise a previously submitted rating or assessment as long as that participant has not selected the confirm all assessment option 650. This enables each event to be assessed on its own merit and also based on relationship to the assessment given to other events. For some embodiments, all assessments are automatically confirmed when the administrator closes that activity on the close date, shown as 660.

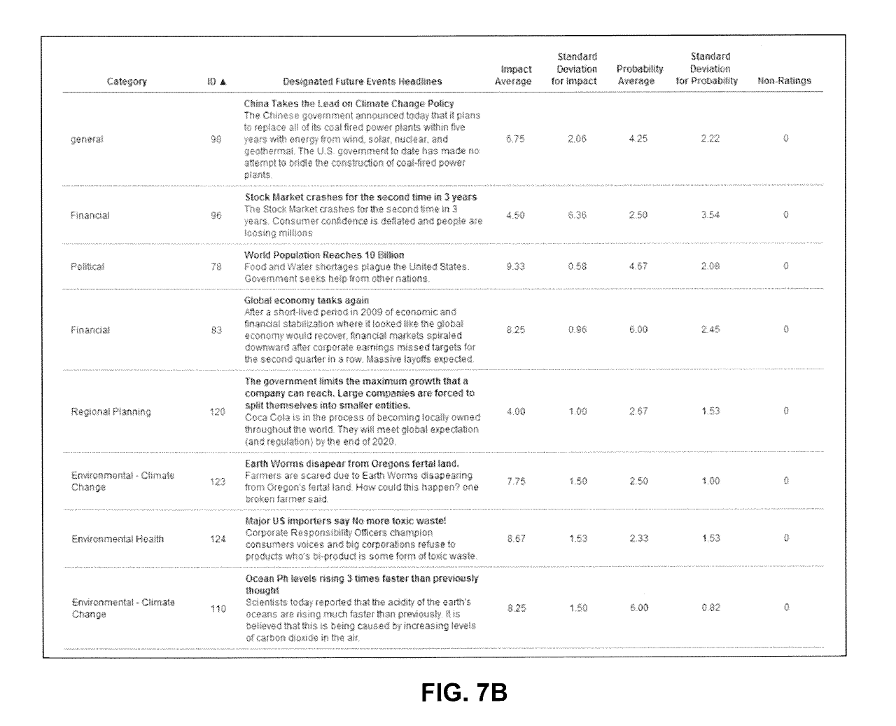

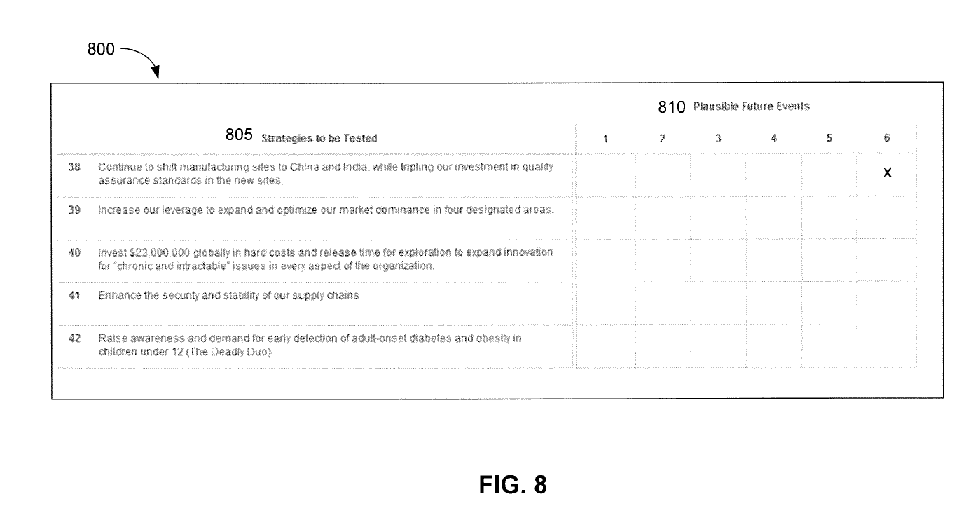

FIG. 7A is an example user interface that displays an impact vs. probability graph based on assessments of the participants, in accordance with some embodiments. User interface 700 includes a graph having an x-axis 710 that represents the probability that the event may occur and a y-axis 705 that represents the impact of the event if the event does occur. As mentioned earlier, the impact may be based on a condition (e.g., economy, politics, etc.) set by the administrator. In the current example, the graph is a scatter plot that shows where various events fall on a grid based on an average of the assessments of the participants. The data included in the graph may be sorted in different orders. Selections may be available to enable the participants to have the data displayed in different views. For example, the views may include linear view, statistical view, standard deviation view, etc. The user interface 700 may also include an event/headline selector section 725 to enable the participants to view data associated with different events/headlines.

FIG. 7B illustrates example outcome table of future events assessment from the participants, in accordance with some embodiments. The results from our assessments of all the designated future event Headlines can be viewed in the table and scatter plot chart shown in FIG. 7A. The participants can modify how the data is presented in the table by filtering by category, searching on key words or phrases, and sorting within the table. The participants can also modify what is displayed in the scatter plot by selecting a subset of the future event headlines that the participants want to view. All the columns in the table can be sorted except the designated future event headline. By selecting and clicking the column heading, the future events are sorted. By clicking a second time and the data will be sorted in the reverse order. For each future event, FIG. 7B also illustrates impact average, probability average, standard deviation for impact and standard deviation for probability.

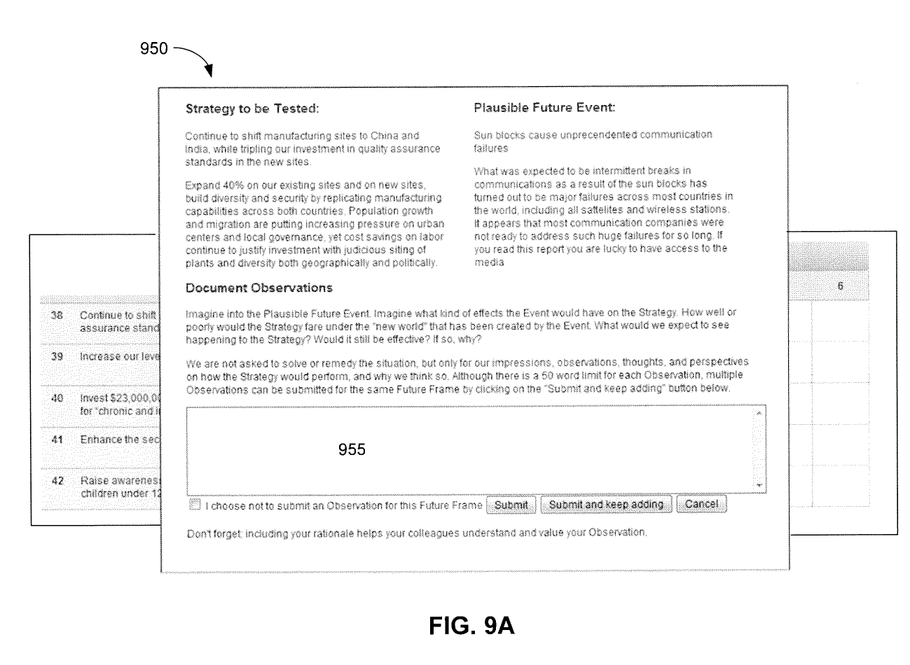

An administrator may set a time limit for the participants to determine the impact and probability of an event. After the expiration of the set time, the inputs provided by the participants are sorted and statistically presented in a graph (e.g., the plot illustrated in FIG. 7A), enabling each input to be highlighted and reviewed by all participants. This builds trust so that people can see that the choices of the “events” that are in the top of a matrix (as described below with FIG. 8) have not been manipulated by management.

FIG. 8 illustrates an example windtunneling matrix, in accordance with some embodiments. Matrix 800 includes a list of strategies 805 and a list of future events 810 to be tested against one another. The administrator may determine the events to be tested. For example, the number of events may be set as 10. The identified strategies/operations/activities to be tested are listed in the left side of the matrix. The participants then select a strategy and an event, imagine into that reality, and provide into the cell corresponding to the selected strategy and event what the participant thinks would happen to the strategy under those circumstances. A cell may also be referred to as a future frame. For some embodiments, a group of participants can review any given frame after all of the participants have provided their observations (or imaginations). The administrator may then make available a cell or an entire row of cells for the group of participants to review individually. The participants then record their ideas, patterns, and emergent suggestions for how to improve the strategy in a resilience frame. For the resilience findings, the organization leaders and participants then review the ideas to decide which ones to pursue through further systemic methods for development and refinement, feasibility, etc.

Each of the participants reviews a row, and then records whatever patterns, themes, ideas, or questions that will enable the organization to redesign/modify the strategy under consideration to be improved, usually to make it more resilient to future changes. The matrix 800 also enables the participants to view the inputs by column, assuming that a given event actually occurred, and determine how the organization can build strategies that will insure its survival or continued operation if such an event actually came to pass. This is all part of an anticipatory design strategy that capitalizes on diversity, imagination, and emergence. Moreover, this all occurs within a disciplined process in a relatively short amount of time.

In the current example, each of the future events is listed as an event number. At an intersection of a strategy and a future event is a cell (or frame). For example, the cell that represents an intersection of the strategy 38 and the event number 6 is marked with an “x”. In order to provide am observation and rationale, a participant may select the appropriate intersecting cell (or place a cursor within the boundaries of a cell and click a mouse button). An administrator may determine from the statistical data (e.g., the data illustrated in FIG. 7A) which events to include in the matrix 800 for the participants to use as the “reality” in which they will consider each strategy/operation/activity that the administrator/organization seeks to test.

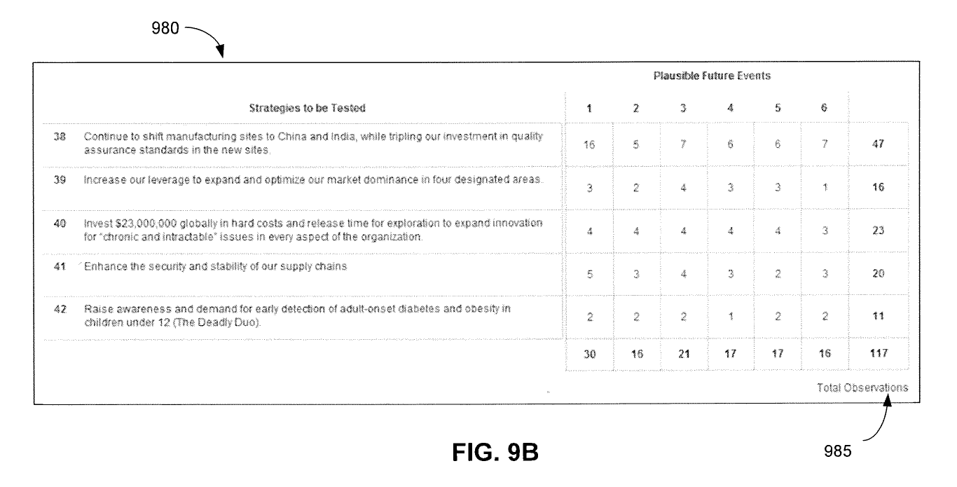

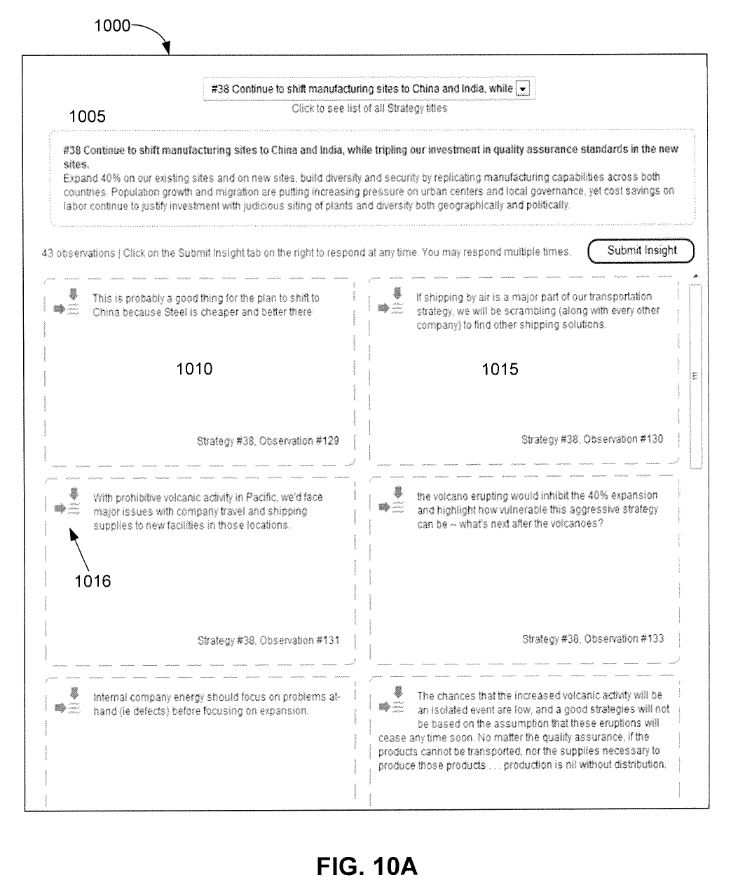

FIG. 9A illustrates an example user interface that may be presented to a participant to enable the participant to provide observations and rationale, in accordance with some embodiments. User interface 950 may be a popped-up window that appears when a participant selects a particular cell of the matrix 900. The user interface 950 may display detail strategy information and detail event information associated with the selected cell. The user interface 950 may also display information to help a participant understands how to provide the insight along with an input area for the insight to be entered. For example, the help information may be “Imagine what kind of effects the event would have on the strategy”, and “how well or poorly would the strategy fare in the new world that has been created by the event?” and so on. For each observation provided, a participant may also provide a rationale why the observation was formed.

FIG. 9B is an example windtunneling matrix that illustrates an outcome of observations provided by the participants, in accordance with some embodiments. Matrix 980 is similar to the matrix 800 illustrated in FIG. 8 except for the number of observations recorded for each of the cells. As each participant provides an observation about the strategy and event associated with a cell, that observation is recorded and a number of observation associated with the cell is increased by one. It may be noted that a participant may have the option to decline providing an observation. As such, the number of observations for each cell may be different, as illustrated in the matrix 980. The matrix 980 also includes the total number of observations recorded per strategy for all of the events, the total number of observations recorded per event for all of the strategies, and the total overall number of recorded observations 985. A symbol may be displayed in a cell that a participant has contributed personal observation. This allows the participant to know where in the matrix that the participant has visited. For some embodiments, when a participant positions or hovers a cursor of a pointing device (e.g., a mouse) over a cell, all of the strategies and events associated with that cell may be displayed in a pop-up window. Alternatively, the participant may need to click on a cell to have the strategies and events displayed.

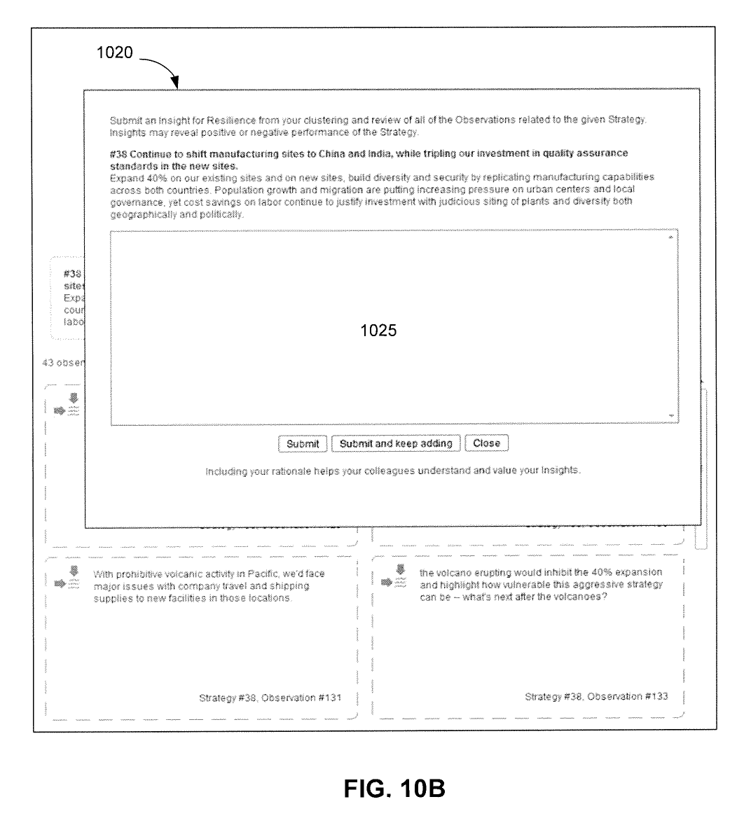

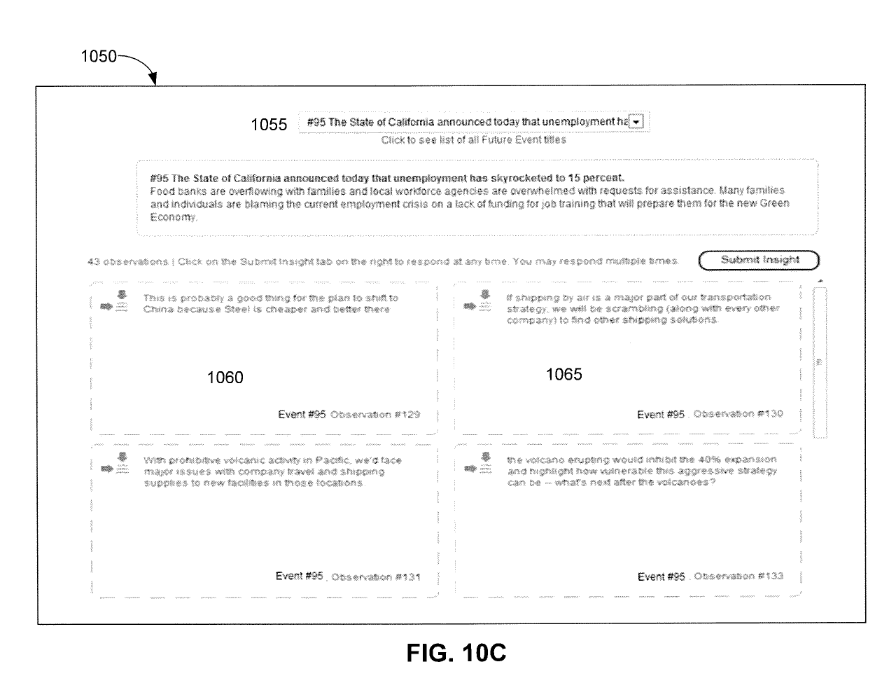

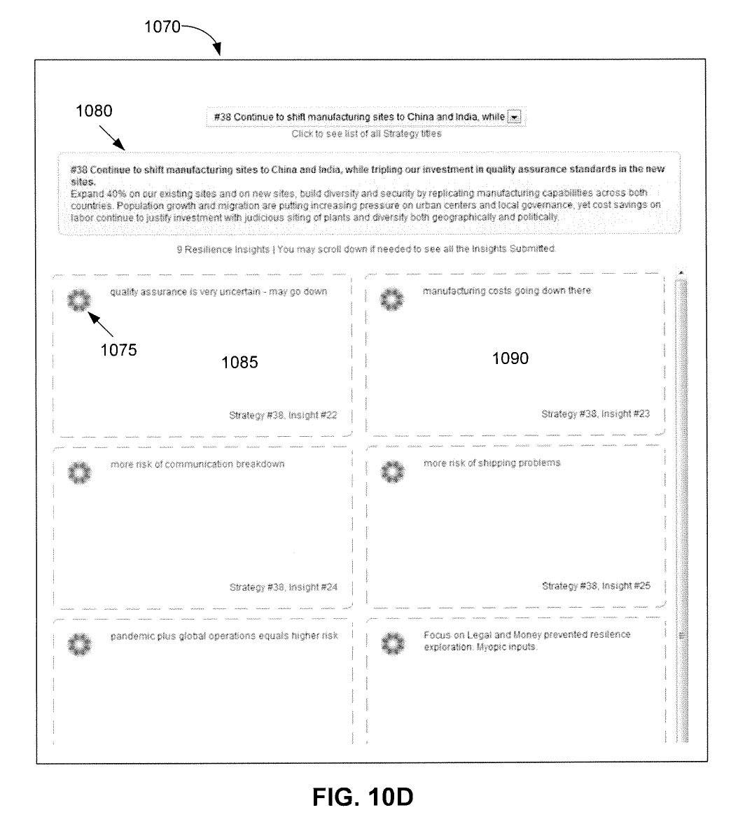

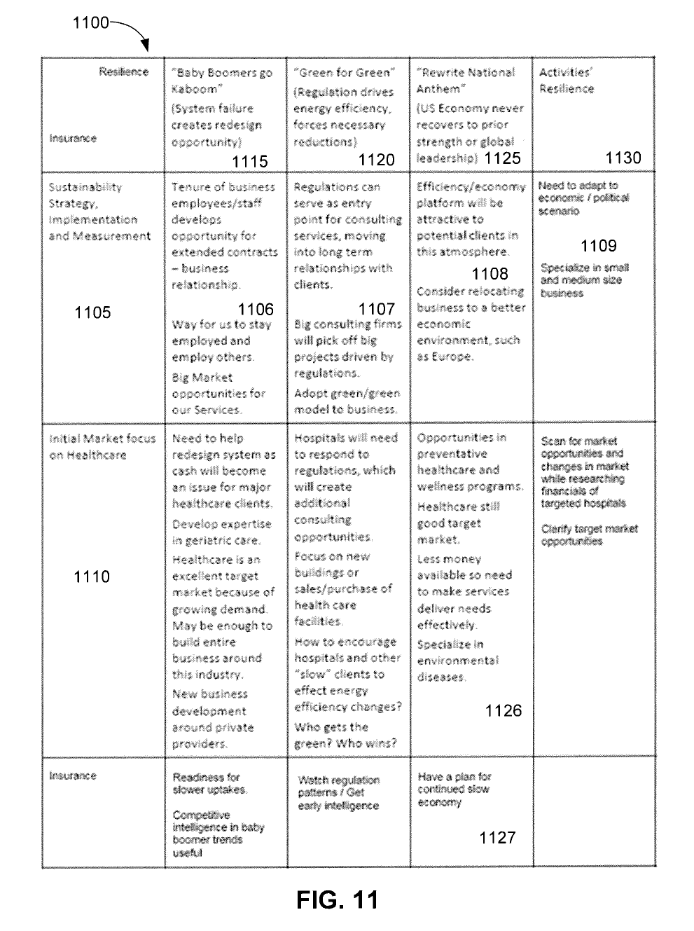

FIG. 10A illustrates an example user interface that provides detail information about the observations recorded per strategy, in accordance with some embodiments. User interface 1000 may enable a participant to select a strategy and view all of the observations associated with that strategy. The detail information about a selected strategy is displayed in block 1005. In the current example, the observations for the selected strategy are displayed in separate panels such as, for example, panels 1010 and 1015. Each panel may also include information to identify the associated observation number and strategy. For example, the observation displayed in the panel 1010 is associated with strategy 30 and observation 129. Each panel may also be associated with an icon such as, for example, icon 1016 to indicate that the panel includes an observation. For some embodiments, each of the panels may be viewed on the display of a client computer system, and a participant may be able to view all of the panels by dragging or moving them on a desktop using a cursor control device.

FIG. 10B illustrates an example user interface that may be presented to a participant to enable the participant to provide insights, in accordance with some embodiments. User interface 1020 may be a popped-up window that appears when a participant selects a submit insight button from the user interface 1000 illustrated in FIG. 10A. Insights may be entered in the input area 1025. Multiple insights may be submitted per strategy.

FIG. 10C illustrates the same user interface as illustrated in FIG. 10A except for the observations displayed are associated with a future event. User interface 1050 includes an event title 1055 and observations 1060 and 1065 about the event 1055. Insights may be entered in the input area similar to input area 1025 of FIG. 10B, and multiple insights may be submitted per event.

FIG. 10D illustrates the final outcome of all the insights for each strategy, in accordance with some embodiments. User interface 1070 illustrates multiple insight panels. Each insight is displayed in a panel such as panels 1085 and 1090. Each of the panels may be viewed, rearranged and placed in clusters on a desktop. An icon such as icon 1075 is displayed to indicate that information included in a panel is an insight. For every strategy, there is a cluster of insights. Another user interface similar to the user interface 1070 may be used to display multiple insights per future event. A user interface similar to the user interface 1070 can also be used for the future events. For every event, there is a cluster of insights. Each individual panel may be grouped with other panels in groups or clusters using a cursor control device. They may be rearranged so that related panels may share the same cluster. Small groups of participants may be able to view the same panels.

To optimize the total insights and ideas for innovation developed by the participants through the foregoing steps and activities, maps of the insights are prepared by the administrators and/or participants to optimally communicate the insights for multiple organizational purposes. These future insight maps enhance the knowledge management and effectiveness of the organization as its managers and leaders fact complex issues. The maps become sources of further productive exploration of risks, opportunities and innovations.

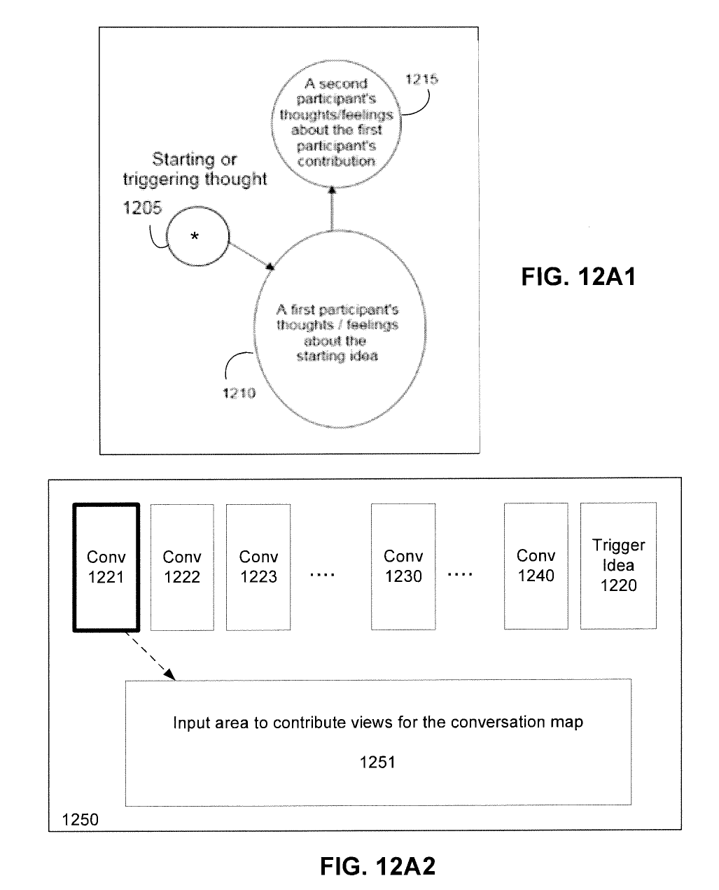

FIG. 11 is a table that illustrates an example outcome of resilience and insurance, in accordance with some embodiments. Table 1100 includes strategies 1105 and 1110 in the first column. The table 1100 also includes the events 1115, 1120, 1125, and 1130 in the first row. Content of blocks 1106, 1107, 1108 and 1109 are insights for the strategy 1105. Content of blocks 1108, 1126 and 1127 are insights for the future event 1125. The insights in the table 1100 may be shared and the organization leaders/participants can determine which insights to pursue for further systemic development/refinement/feasibility.

### V/ Conversation Insight Mapping

Conversation insight mapping is a technique that enables people to contribute comments, from their client computer systems, their own perspective about a trigger issue that needs to be explored and to also comment on anyone else's contribution. In an environment where only oral communication is employed, the conversations tend to gradually narrow to reach a certain point or conclusion. For example, a business meeting is a form of conversation mapping using oral conversation. On the other hand, when the conversation mapping employs written communication, for example as in using an online web-based system, the conversations tend to keep expanding until knowledge of the participants is captured and stored in the database. The captured knowledge represents all that is known, from multiple and diverse perspectives. From the captured knowledge, emergent patterns may be identified. The emergent patterns may lead to alternative ways to leverage improvement in a complex issue.

The conversation insight mapping can be used to solicit emerging issues and ideas from a large group of stakeholders in a brief period of time. The conversation insight mapping comprises a set of tools scripted in code to collect the knowledge of a complex issue that is possessed at different levels of a diverse group. The knowledge collected in the map provides a word-rich picture of a complex issue. A core concept at the center of the map triggers the responses from the participants. As the rich picture of the issue emerges, the map reveals previously unrecognized patterns of variables that are unique to the issue. Known as emergent themes, these patterns can indicate ways to transform the issue in positive ways. The conversation insight mapping is coded to receive inputted information and supply one more user interface to convey generated output to:
Reveal “received knowledge” assumptions, communications inadequacy or anticipated changes that may hamper progress;
Stimulate innovation; and
Facilitate integration of knowledge held but not shared at different levels of a group due to hierarchy or specialty silos.

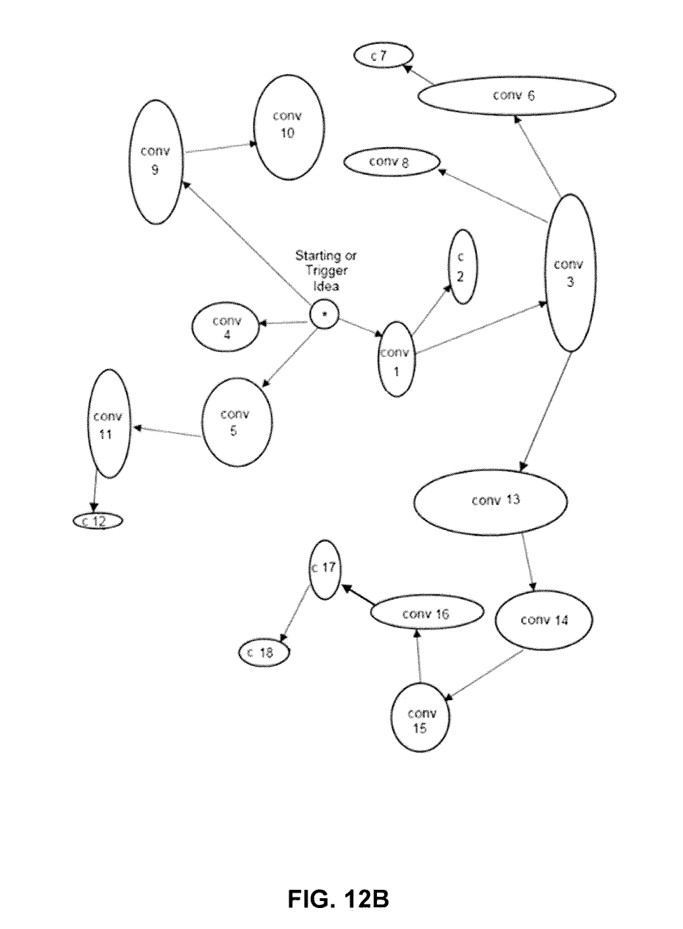

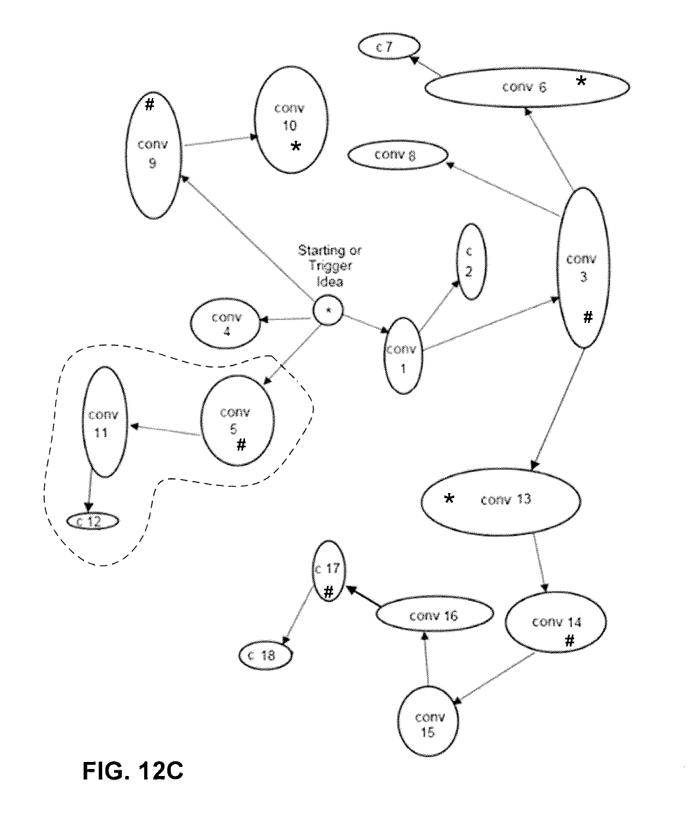

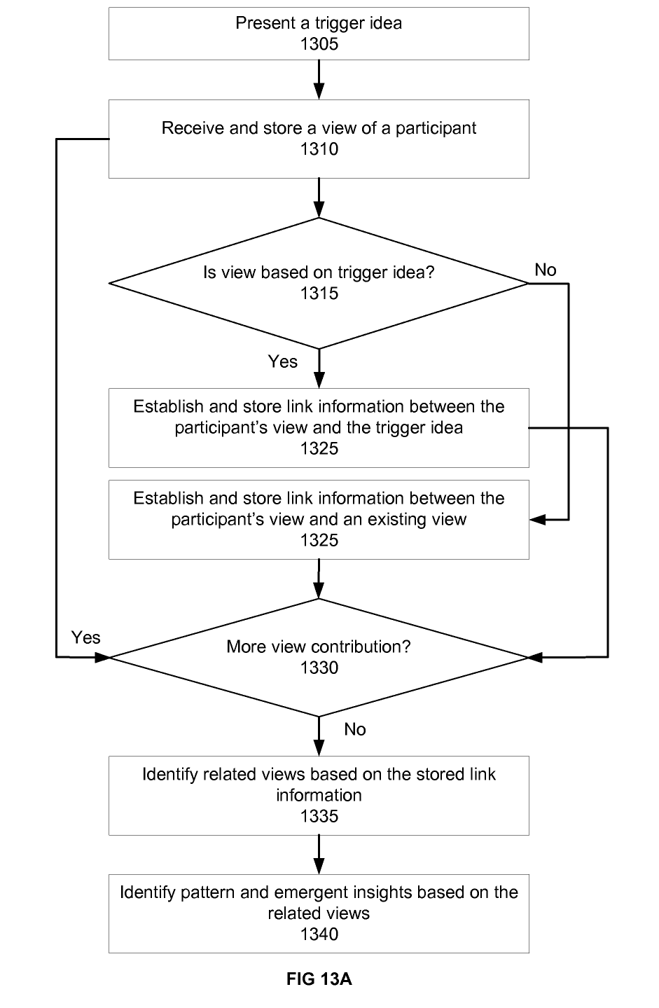

FIG. 12A1 is a diagram that illustrates a simple example of a conversation, in accordance with some embodiments. A conversation may begin with a trigger idea such as, for example, global warming. A first participant in the conversation may contribute his/her view about global warming forming a first view. A second participant in the conversation may contribute his/her view about global warming or about the view of the first participant, and so on. Referring to the example in FIG. 12A1, a conversation begins with a trigger or starting idea 1205. This trigger idea 1205 may be initiated by an administrator and presented to a group of participants on their client computers. A first participant may then use a client computer system to contribute or provide view/thought/feeling 1210 (referred to herein as a conversation) generated based on the trigger idea 1205. The conversation of the first participant is recorded and stored in a database. A second participant may then use the same client computer system or a different client computer system to contribute or provide conversation 1215 generated based on the conversation 1210. A third participant may then do the same and so on until all of the participants have the opportunity to express their contribution. For some embodiments, when the participants express their views using the client computer systems, their participation may not necessarily be sequential, but can also be substantially simultaneous. The participants may contribute as often as they desire. The process proceeds until all of the participants have contributed all their relevant knowledge about the trigger and other participants' contributions.

It may be noted that the conversation insight mapping may allow a participant to contribute a different view based on the trigger idea, or an opposing view based on a view contributed by another participant, or a view that possibly expands beyond an existing view contributed by another participant. FIG. 12A2 is a block diagram that illustrates an example user interface that may be used to allow a participant to contribute a conversation, in accordance with some embodiments. The user interface 1250 may display the triggering idea 1220 along with the conversations 1221-1240 contributed by the participants. Each of the conversations 1221-1240 may include information to show a conversation that it relates directly to. For example, the conversation 1221 may include information showing that it is related to the trigger idea 1220. The conversation 1222 may include information showing that it is related to the trigger idea 1220, etc. A new conversation may be contributed by selecting one of the existing conversations 1221-1240 or the trigger idea 1220. When selected, a conversation may be highlighted and a conversation input area 1251 may be presented. In this example, the conversation 1221 is highlighted to show that the new conversation entered in the input area 1251 is related to the conversation 1221.

A participant is not limited to contributing or expressing only one view or thought. Each participant, however, is required to indicate which of the existing thoughts his or her contribution is related to. For example, the participant may use a cursor control to select an existing view and then contribute own view or thought via the input area 1251.

The conversation insight mapping is scripted in code to provide complexity management, knowledge management, experiential learning, collaboration development (team building), systemic methods, project management, risk management, negotiation, and other functions. The conversation insight mapping provides a framework and process by which the diverse experiences of people affected by a complex issue can be integrated quickly to produce a single rich picture (or map) of the complex issue in focus. The rich picture is a multidimensional, and multidisciplinary database from which novel emergent relational patterns between issue variables can be identified and considered for improving an organization's or individual's performance within the issue. The process generates a collaborative culture between the diverse participants that ensures that emergent patterns for improvement are owned by all participants. Such emergent patterns may not emerge if there is no diversity of experience and opinion among participants.

The conversation insight mapping is scripted in code to:
capture multi-perspective observations/ideas/questions that are based on different life experiences, technical and profession training, attitudes and values about a common focusing issue in a single interactive, unconventional yet meaningful database.
track participation that is transparent and demonstrative of the immediate difference a participant is making to the insights embedded in the Map.
provide a capture method that is not constrained by time availability; physical location; organizational hierarchy; or any other structural barriers that limit participation such as language differences, cultural taboos etc.
enable anonymous conversation contribution

The conversation insight mapping enables:
Making sense of the map is an open-ended process and can be carried out by any of the participants or observers. This capitalizes on the emergence and patterning capacity of humans, drawing up new ideas to be developed and refined.
Highly efficient use of staff time reducing time required for traditional brainstorming sessions to explore complex issues while producing a superior interactive database.
Tens of participants can participate simultaneously; they can join a conversation underway on a similar or different topic.
Completed maps serve as monitoring, evaluation and early warning system for changes to the issue in focus made after the map was assembled. This enables early identification of weak signals of unintended consequences through patterning across diverse maps.

The conversation insight mapping addresses an intense need for cross-silo communication to share knowledge and build living networks that are interdependent but currently are disconnected. Integrated planning is essential to an organization's future survival. Complexity is the single greatest barrier to a sustainable future, and the conversation insight mapping enables administrators to enable diverse groups to “converse” and learn, to be both humbled and excited by the possibilities. The market recognizes that conventional strategic planning processes are not demonstrating improvement in any sector, primarily because they are dependent on “expert knowledge” and fail to capture the embedded knowledge held by their staff and stakeholders.

FIG. 12B is a diagram that illustrates an example map having multiple views contributed by many participants, in accordance with some embodiments. Map 1260 includes a trigger idea in the middle (represented by an asterisk). From that trigger idea, four independent conversations 1, 4, 5 and 9 are generated by four different participants. From the conversation 1, conversations 3, 13, 14, 15, 16, 17, and 18 are formed. Similarly, from the conversation 1, conversations 5, 11 and 12 are formed, and so on. As can be noted, the map 1260 may continue to expand to include many more conversations, either branching off from the trigger idea or from an existing conversation. As noted before, a participant may contribute one or more conversations. The map 1260 may be referred to as a conversation insight map (CIM).

FIG. 12C is a diagram that illustrates groupings of related views, in accordance with some embodiments. Different threads can be formed based on the conversations included in the conversation map 1280. One example thread is highlighted in dotted lines includes conversations 5, 11 and 12. Another example thread includes all the conversations that are highlighted with an asterisk (“*”). This includes conversations 6, 10 and 13. Another example thread includes all the conversations that are highlighted with a pound sign (“#”). This includes conversations 3, 5, 14 and 17. For some embodiments, each of these threads may be used to identify patterns or insights that may be helpful to an organization.

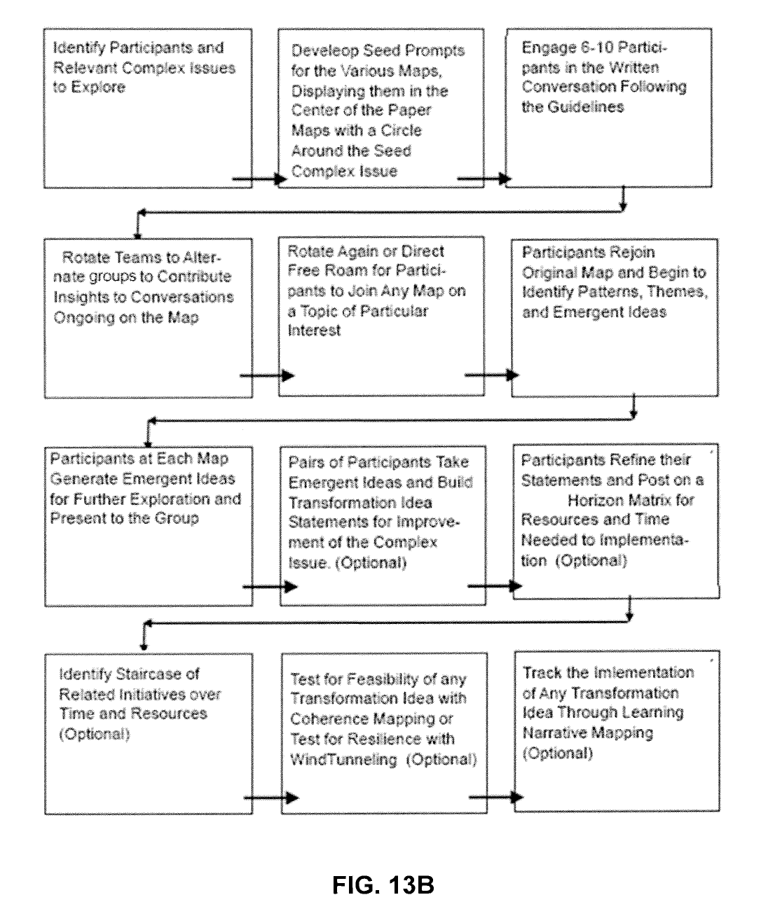

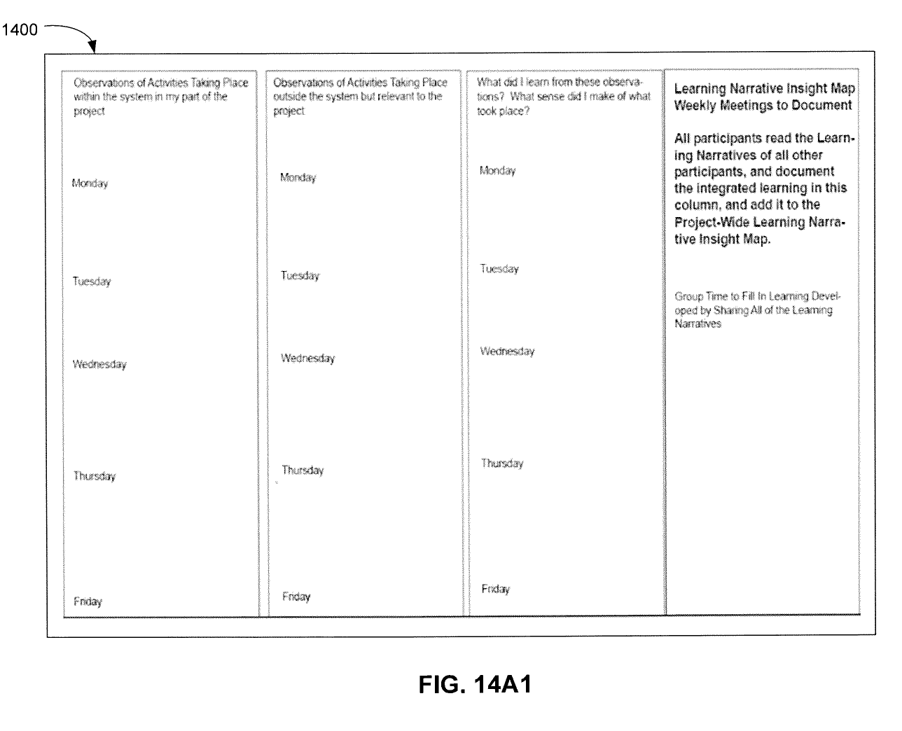

FIG. 13A is a flow diagram that illustrates an example of a conversation insight mapping, in accordance with some embodiments. The conversation insight mapping may run on a client computer system, a server computer system, or a combination of both in a client-server environment such as, for example, an online web environment. The process starts at block 1305 where a trigger idea is presented. At block 1310, a view contributed by a participant is received and stored in a database. At block 1315, a test is performed to determine if the view is based on the trigger idea or based on an existing view. If it is based on the trigger idea, the process continues to block 1320 where link information associated with the trigger idea is stored along with the view just received. From block 1320, the process continues to block 1330.

Returning to block 1315, if the view is based on another existing view, the process continues to block 1325 where link information associated with the existing view is stored along with the view just received. The process continues to block 1330 to determine if there is another view to process. If another view is received, the process returns to block 1310 and repeat those operations. If there is no other view, the process continues to block 1335 where related views are identified. At block 1340, patterns and emergent insights may be determined from the related views. The conversation insight mapping described in FIG. 13A highlights some of the operations to be performed. Other operations and information related to the conversation insight mapping may include the following:
The conversation insight mapping is based on conversation, where brainstorming is a random series of ideas that may be related, but are often discrete.
Information from participants is generated by interactive conversation using their client computer systems, through a process of written/typed/speech recognition converted conversation, in which one contribution becomes the stimulus for other contributions, each participant being free to take the conversation into new directions, depending on his/her knowledge and insight.
Many contributions can be made simultaneously enable a very rapid sharing of knowledge and highly efficient method of issue exploration—which enhances engagement and interest.
Contribution of each participant is stored in the database enabling continuous tracking of participation.
The conversation insight mapping can generate immediate visual presentation of the status of the exploratory conversation by displaying the information on the client computer systems.
The conversation insight mapping provides a fully mobile platform to facilitate participation at successive times and places as required. When implemented as a web-based application, the participants may not be restricted to one common location.
The conversation insight mapping provides for disclosure of knowledge that may have been withheld by participants, however it is revealed in an anonymous setting, supporting transparency in the organization.
With the conversation insight mapping, many participants can contribute at substantially the same time.
Patterns of relationships between variables emerge as the map is developed and cannot be manipulated by any single interest group or powerful individual.
The conversation insight mapping can be used for any problematic at very short notice with outstanding results, if the people participating have diverse perspectives of the problematic and are prepared to engage in sharing those perspectives.
The conversation insight mapping works to diffuse tense situations as people are able to put their ideas down, “listen” by quietly reading to others' responses, and then add further thoughts. Intimidation is limited and the group can get more quickly to the heart of the issues of contention and expand on previously unseen opportunities for improvement.

FIG. 13B is a flow diagram that illustrates another example of a conversation insight mapping, in accordance with some embodiments. Each of the blocks in FIG. 13B includes description of its associated operations. The conversation insight mapping is neither time nor geographically bound in its generation or interrogation. The map can be viewed by different group of participants to ensure that many separated perspectives are captured. New participants can quickly engage with the conversation that has gone before by adding their contributions. The contribution can be new themes or additions to themes already presented. The participants may contribute and re-contribute as over a period of time to allow them the opportunities to reflect. The conversation insight mapping enables the participants to articulate different perspectives of a situation and the interaction (relationships) between the several perspectives that are captured, generate an opportunity for all stakeholders to understand the different perspectives of a situation and to modify their personal understanding in the light of others perspective, and provide an opportunity for all stakeholders to mutually identify emergent properties of the problematic situation that were not previously available and which may be the basis for new probes to explore and improve the situation.

### VI/ Learning Narrative Insight Mapping

A learning narrative insight mapping is a process for presenting a story of a project. It is designed to capture the project (a system) as the participants (subsystems) experience the systems performance in the ever changing environment (suprasystem), identify the participant's learning from the interplay between the system and the suprasystem, and invites the reader (or listener) to draw their own learning from the story, which may have wider application in the system's operation. The learning narrative is a knowledge database designed to capture project experiences, participant's new learning, question and preferred practices. Learning narrative insight mapping includes a set of tools scripted in code to enable capturing of organizational knowledge based on the experiences of a program or project's participants.

The learning narrative insight mapping allows identifying the boundaries of the specific system under review, clarifying the elements of the margin that are within the boundary and those beyond the boundary. Elements close to the boundary are subject to “marginalization” and need special attention to assure clarity. For example, a water board and a local community are exploring water conservation. That is a complex issue with many variables, each variable (weather, regulations, customer use, new industries coming to the area, etc.) constantly changing and most out of control of the organization. The specific boundary of the system that they need to establish has been determined to be small business (e.g., fewer than 50 employees) use and residential use within a 6 mile radius of the area's main water treatment plant over a 12 month period.

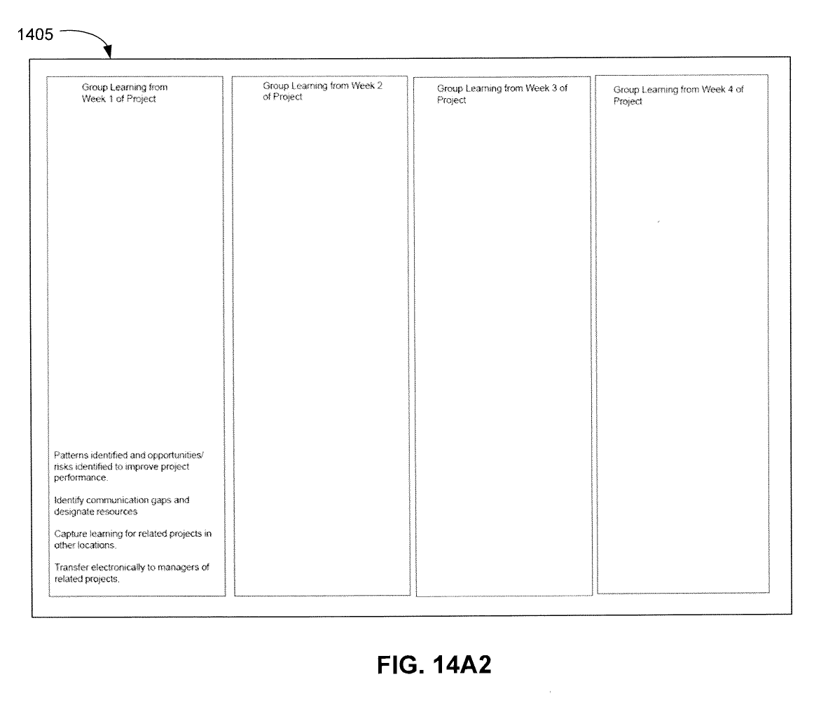

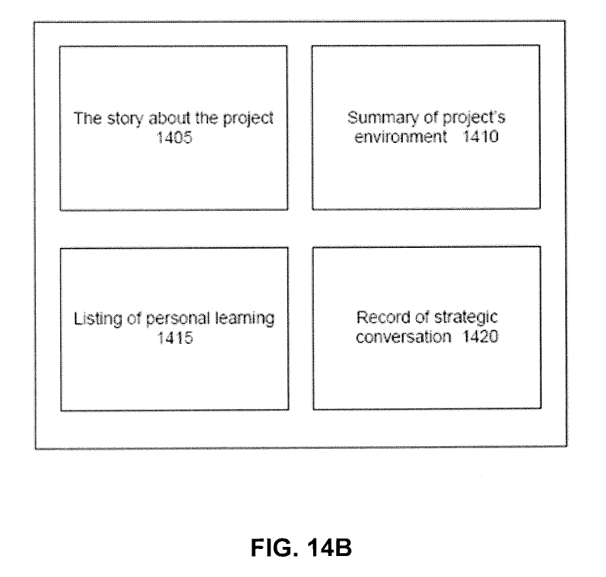

FIGS. 14A1-14A2 illustrate example user interfaces that a participant may use to track observations, in accordance with some embodiments. User interfaces 1400 and 1405 may be viewed on a display of a client computer system. All participants representing the organization involved in managing this initiative track their observations daily throughout the project time frame. Participants observe what is going on within the system that day with respect to its engagement with the suprasystem, and document it in the first column of a template or form that is used by all participants. All participants then record what they observe is going on beyond the system (in the suprasystem) that they find relevant to the system, in a second column, again on a daily basis. In the third column, each individual documents what they learned that day about the project based on all of their observations, drawing any inferences or relationships among what is happening within and beyond the system with respect to the system achieving its purpose in the suprasystem circumstances. Weekly or bi-weekly, all participants read the learning narratives of all of the other participants and optimally they converse about their learning and observations. Insights from these convergent meetings, or integration of the information is brought together to enable all participants to see what everyone else in the project observed and learned, and are able to compare it. Insights from these learning narratives are then generated into learning narrative maps that can inform all participants and broader stakeholders that have an interest and may have a controlling ability over aspects of the projects success.

The learning narrative insight mapping treats a complex project as a system that is affected by internal dynamics and external variables. The story of the project is told in terms of a chronology of events within the project with associated feelings and intentions, a summary of what is happening in the project's environment, and a listing of the participant(s)' personal learning about the project. The report generates a strategic conversation that captures and adds to corporate/organizational knowledge. The learning narrative insight mapping is coded to receive inputted information and supply one or more user interface to convey generated output to create and capture shared understanding of learning processes in a project, provide insights into a better work practice, and reveal Patterns that provide direction to a preferred adaptation or future. The learning narrative insight mapping assist in facilitation, education programs, green business development, environmental auditing, train the trainer, finance programs and others developed to respond to an entity needs or another in which the program is designed to influence the environment in which it is operating. The learning narrative insight mapping helps organizations understand the implications of resource and regulatory uncertainty so they can adapt and build the resilience of their organization. As the conditions that are challenging organizations become ever more turbulent, the methodologies used in these tools reveal their increasing value for continuous adaptability and innovation. Real-time, on-the-ground personal observations and learning contribute to invaluable insights for project and general managers of complex issues. The integration of the individuals' learning build additional learning in a culture of humility and respect.

The learning narrative insight mapping may be scripted as a stand-alone application with algorithms and routine to run the functions or a suite of applications that coordinate and have interoperability between each of the functions. The learning narrative insight mapping may be resident on a host machine or a chunk of code that can be installed and executed within any separate HTML-based web page by an end user without requiring additional compilation. The learning narrative insight mapping is scripted in code to provide project management, stakeholder engagement processes, capture of experiential learning outcomes and innovation management. The learning narrative insight mapping is coded to provide adequate form and freedom for participants to be accountable 1) to report what they observe, 2) to document what sense they make out of it, 3) share their learning with their colleagues at regular intervals, and then captures resultant insights for corporate learning. Diversified perspectives, rigor in observation and thinking, and collaboration enables emergent ideas to come to the attention of management and everyone on the team, leveraging the intellectual and time investment across the organization. The learning narrative insight mapping is also available for newcomers get up to speed quickly, inform managers quickly of what the team has been accomplishing, and what the team deems of value, and where problematic issues are building up pressure.

The learning narrative insight mapping is scripted in code to:
facilitate meaningful conversations about specific observations and inferences drawn by participants, sharing a common purpose, over time,
require certain frames around the observations and learning by individuals throughout a project episode, and sharing of observations at regular intervals,
ask participants to observe for activities, strengths, weaknesses, failures and successes.
asks participants to record what the system is doing and what they infer or learn from their observations;
sets up regular times for participants to read each others' observations and identify emergent issues and opportunities.
   A tracking and documentation system has specific frames around the observations and information to be tracked. The learning narrative insight mapping asks the participants to crystallize what sense they make of an observation or experience. The learning narrative insight mapping has a frame that requires participants to read what others have observed, thought, and learned. The tasks of the participants are functionally and sequentially unique from other risk management, project management, or complexity management processes.

In addition, the learning narrative insight mapping is scripted to allow all this to be done online, in web-based software and shared globally at regular intervals, providing structure and expectations for global teams and enabling people to prepare for conference calls by reading and getting more value from the invested time of the participants. Better questions are generated and people move from symptoms to root causes much more quickly as multiple observations let people hone in on what is really going on. It is also intellectually more exciting, and builds a culture of increasing respect because complex issues require multiple perspectives and yet cannot be burdensome in terms of time.

Poor communication and isolation in a fast-moving economic enterprise yields lost learning, lost earnings, and loss of intellectual capital. The learning narrative insight mapping is a disciplined practice that supports individuality and community by requiring participants to document their observations, record their learning or insights/inferences, and share on a regular basis. Enhanced communication flow creates health in any ecosystem, especially one where departments and levels of the organization create blocks to overcome. The learning narrative insight mapping can be done online. It can also be done for windows of time, active for certain windows and inactive for certain windows, and back to active windows. This raises the participants' awareness of the investment of time in recording and sharing, and how that investment throws off dividends from increased engagement to morale to faster time to market with better ideas. Using the learning narrative insight mapping, the participants begin to see that their observations are needed, valued, and their learning promotes their personal path but also the organization's path toward a wide variety of organization goals.

FIG. 14B illustrates the four components of learning narrative, as they are detailed by each participant sequentially each day, and then the learning is shared weekly or bi-weekly among all participants, in accordance with some embodiments. The learning narrative insight mapping provides fields and screens in that it asks for unique, independent observations so the discretion of each participant from his/her unique perspective is captured. Participants respond to the structure by having to characterize what they learned from how systems interact. The participants have to clarify meaning to fill in that part of the process. The sharing column captures, through interaction and conversation, key learning for the organization that can then be sent out throughout the organization and vetted against others' perspectives. If the right questions or prompts are not present, the participants will withhold what they do know, thinking that it is unimportant, and that they are unimportant, unrecognized, and eventually resentful. The learning narrative insight mapping can work to release the embedded knowledge, observations and insights and work in a quiet but powerful way to build a culture of thinking and respect.

An example of some aspects of the learning narrative insight mapping is shown below.
Purposes: To activate the “making-sense” process in a critical learning system and make the output visible for others to share and critique. To build corporate learning from the unique experiential learning of a program's participants.
Theory: In exploring a program as if it were a system involves examination of the internal dynamics of that system. Those dynamic concern the interaction between the sub-systems, between the subsystems and the system, between the system and the supra system (the system's environment) and between the subsystems and the supra system. The latter of these dynamic relationships includes the experiential learning that enables the system to evolve and optimise its performance. The efficiency of the learning in terms of system improvement is shaped by the intentionality of the learning and its sharing across the subsystems. A learning narrative is a format for presenting the experiential learning occurring within a system (project).
Process: The learning narrative insight mapping has four parts and the information from each part is recorded in four parallel columns. The columns are headed as:
   1. System in focus activities;
   2. Influences on the System from its environment;
   3. Personal learning; and
   4. Collaborative learning.
      Project participants gather the information for the narrative from their reflections, conversations with others in the project, and through reviewing project documentation. The information is then recorded and stored in four different groups, as illustrated in FIG. 14B, and as described below:
1. The story about the project 1405 (system in focus) as told by the participant covering the chronology of events, feelings about these events plus his/her own reasoning and intentions associated with the events.
2. A summary of what the learner perceives to be relevant and important in the project's environment 1410.
3. A listing of the writer's personal learning from the project 1415, including the operational aspects of the project, the project's attempt to accommodate external influences and emerging external influences that may impact on future projects. (This information is recorded in the second from right-hand side of the table.)
4. A record of the strategic conversation 1420 generated when others engage with the participants to explore the significance of the individual learning to other projects and the future of the whole organization. Learning narratives, like any journal, will be of varying length dependent on the extent of activities occurring.

The learning narrative insight mapping can be compiled by:
an individual as a means of exclusively capturing their personal learning for either self development, or for sharing with others who have also completed a narrative on the same project to enable a comparison of experiences and learning;
an external person to the project who interviews project participants and reviews all the project documentation to fill out a story that combines the experiences of all participants before it is presented to a workshop of the team and relevant levels of management to discuss and build on the externals material in the two right-hand columns.

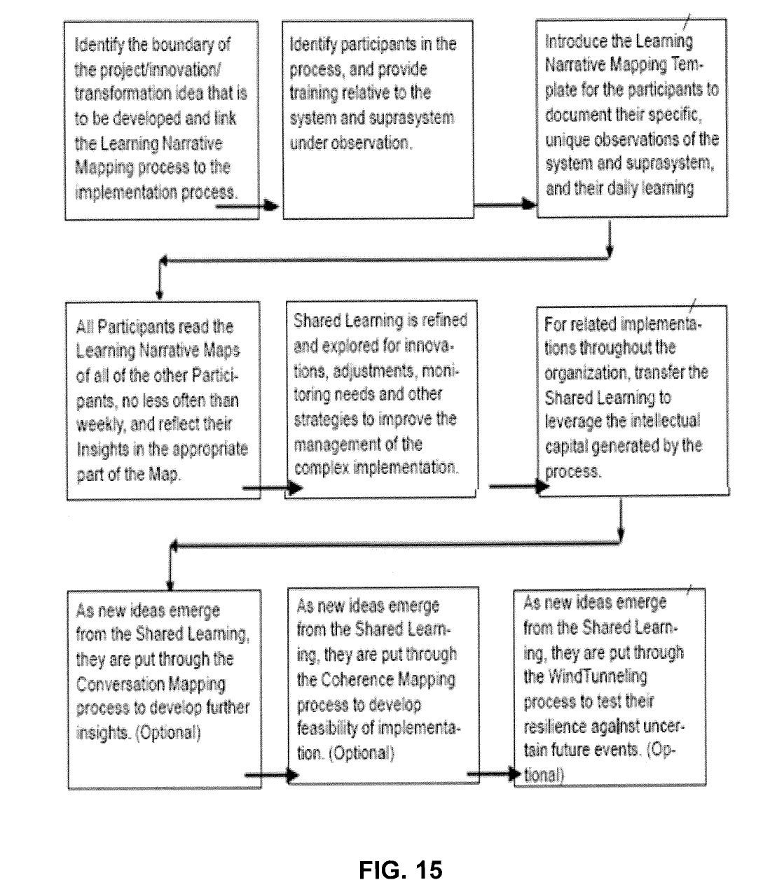

FIG. 15 is a block diagram that illustrates an example learning narrative insight mapping, in accordance with some embodiments. Each of the blocks in FIG. 15 includes description of its associated operations. In reading a learning narrative it is important for a participant to suspend assumptions about any aspect of the project so that the participant can focus on what happened, how the person compiling the narrative describes the events, how they felt and what their learning was. To make use of the experience captured in a learning narrative insight mapping, the participants of the narrative need to come together and openly and honestly discuss their reactions to the stories, and what lessons the contributions by all the participants hold for them.

Individuals in a team or organization all have different prior experiences and attitudes. Even when they have been part of a long mutual history, they often therefore perceive events differently. In the complexity of typical modern business settings, most people do not have the time, tools and common experience to effectively compare their understanding of what happened. That is, corporate knowledge is not added to in an effective and ongoing manner. The learning narrative insight mapping provides the knowledge upon which a group can come to a shared understanding of learning and change processes in a project. Further, it provides an organization the opportunity from which creative and innovative insights into a better work practice may be recognized.

The learning narrative insight mapping can be used in a classroom setting to track individual learning and the learning in the context of current events (the suprasystem) as well as sharing the interpretations/learning of each small group each week of their learning narrative maps. The learning narrative insight mapping can also be used by designated participants to track the evolution of the various strategies as they are invested in, built out and linked to the longer-range goals.

The learning narrative insight mapping has at least two key values to an organization. First, it enables the participants compiling the narrative to identify and consolidate personal learning from the project that will enhance their capability in future projects. Second, the report can generate a strategic conversation within the organization about the project and its environment that can add significantly to corporate knowledge and adaptability. The learning narrative insight mapping is a valuable technique to use when the complexity of a project's processes and the impact of many external influences make it difficult to gain an overall understanding of a project's progress or achievements. It is also particularly useful when the organization is seeking to use the project as a basis for further developments, when it is looking for insights into a new competitive edge.

### VII/ Coherence Insight Mapping

The coherence insight mapping is a process scripted in code to provide organizational management and development, risk assessment, strategic planning, feasibility study, anticipatory design, and other functions. Coherence insight mapping maps utilizes existing, diverse knowledge embedded within organizations to generate a map of the needs assessment of a new idea among the functional activities (coherence insight mapping addresses the activities (verbs) not the structures (nouns) in a project or program), of the organization, enabling more accurate resource allocation and revealing gaps prior to implementation expenses. New ideas that can support system-level interventions have stronger successes and the coherence insight mapping supports the networking across functional activities that are necessary to effectively manage complex issues. The coherence insight mapping (also known as conceptual modeling) generally comprises set of ovals for each set of functions that need to be involved to implement an idea, and then there are lines connecting across the ovals, describing what each oval (e.g., marketing function) needs from the other ovals (e.g., financing, administrating, product developing, etc).

When new ideas are explored, rarely do a broad group of stakeholders review the idea and shift among multiple perspectives to identify what each “functional activity” (also referred to as “function unit” herein) needs from the others in order to optimize the feasibility/effectiveness of the new idea. This coherence insight mapping enables diverse groups to engage, shift perspectives, build empathy and reveal embedded knowledge to refine the idea before implementation expenses are incurred.

Diverse perspectives that are integral to this coherence insight mapping reveals structural and functional weaknesses in the organization that can cause the new idea to fail, but which none of the individual participants from the silos or functional units can see alone. The patterns that are revealed prompt relevant questions, resource determinations, new possibilities and collaboration that will be needed if the idea is to grow in a nourishing culture within the organization.

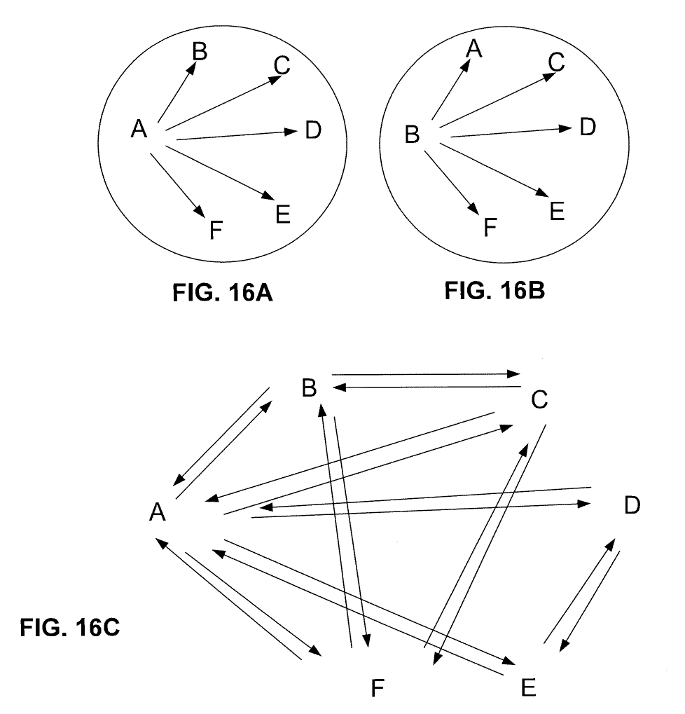

FIGS. 16A-C are example graphical representations of needs of functional units involved in a strategy, in accordance with some embodiments. The coherence insight mapping is scripted in code to work on a “Needs Based Approach”: Each functional unit asks every other functional unit what it needs to be successful. The process may start with identifying a strategy. Then all of the functional units necessary to implement the strategy are identified. Each functional unit is the organized such that its needs are clearly stated. The needs include those that will help the functional unit to successfully accomplish its part of the strategy. For example, as illustrated in FIG. 16A, functional unit “A” asks functional unit “B” what “A” needs from functional unit “B” to be successful. Then functional unit “A” asks functional unit “C” what “A” needs from functional unit “C” to be successful, and so on. Similarly, as illustrated in FIG. 16B, functional unit “B” asks function unit “A” and functional unit “C” what they need from “B” to make their respective activities be successful. This continues until all of the functional units have the opportunities to state their needs. This is the polar opposite of how organizations now work and how current methods are used. For example, marketing does what marketing does and everyone else takes what marketing does. Marketing does not ask financing, product developing, facility managing, human resource managing, administrating, community outreaching what each needs, respectively, from marketing to make an idea successful throughout the organization. Therefore, gaps and resource issues are not addressed until after the budget and strategic plan is underway, and people do not relate to each other effectively relative to the new idea because they don't know what others need (and expect) from them. FIG. 16C illustrates example needs of multiple functional units from other functional units. A color coded representation may be used to represent needs being met (e.g., green), supplies being low or alert (e.g., yellow), needs not being met or disruption (e.g., red), etc.

All of the participants representing their functional units determine where they can meet the needs of all other functional units and where there are gaps. Commitments are made among the units where the resources are available. Where the resource gaps exist, negotiations are entered to (1) determine feasibility of the strategy, or (2) modify the strategy to accommodate the resources available. The process allows tracking on-going needs assessment to (1) anticipate breakdowns, (2) minimize risks, and (3) take advantage of growth possibilities.

The coherence insight mapping is scripted in code to engage wide, diverse stakeholder groups from functional units. The coherence insight mapping makes the information management less burdensome and allows this specific approach to “Idea Feasibility Assessment” prior to launching what seems like a good idea to a “champion” within the organization or leadership team. This coherence insight mapping can reveal that an idea is not feasible without specific investments or resource allocation, knowledge sharing, engagement and collaboration among the organizations functional units. It quickly pinpoints where the gaps are and lets the leadership/participants decide how to proceed.

Coherence insight mapping is perfect for business planning, and the functions that need to emerge to support a plausible, feasible business or marketing plan amongst a diverse group of stakeholders, including clients, investors, the entrepreneurs, the suppliers, etc. Currently, some functional units work is on a “supply driven approach” rather than a “needs driven approach.” Therefore, many ideas falter because the champion/owner of the idea does not know that they are expecting support that is not available or budgeted. Those who cannot deliver feel outraged and victimized thus eroding a culture of trust and innovation. The coherence insight mapping enables people to engage virtually in the process, sharing knowledge on a global scale if needed, and working out of an anticipatory design approach. The networking enhances personal relationships across functional units or silos to develop, furthering the interest, enthusiasm, and buy-in of all participants for a given idea and the hope/possibility for future improvements.

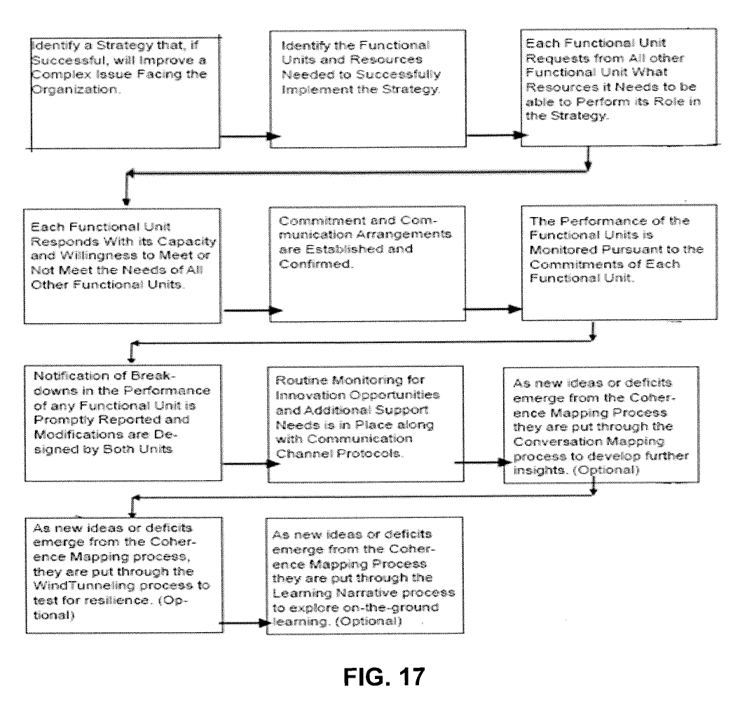

FIG. 17 is a block diagram that illustrates an example coherent insight mapping, in accordance with some embodiments. Each of the blocks in FIG. 17 includes description of its associated operations. The coherence insight mapping works to transform the culture of organizations, nurturing networking and mutual support rather than disappointment, frustration, and “failure” of a new idea that may be pivotal to the organization's success. It also inspires related ideas to become “obvious” when the patterns reveal themselves through the identification of needs.

Innovation and change management are extremely difficult when complex issues are involved. In large organizations, whether business, government, NGO or global governance organizations such as the United Nation, struggle to birth and bring to maturity new ideas at the systemic level. Coherence insight mapping enables broad stakeholders to review what each functional unit will need from all of the other functional units to be successful over time. This raises awareness and system-level coherence that can generate a shared map of the resources that will be needed to bring a new idea to effective maturity. Aborted initiatives are rampant in large companies, and the cause is mostly never explored because of the blame game that precludes a system-level review of the patterns of dysfunction. The actual cost of these wasted efforts are financial, morale, mis-directed resources that are not then available for the health and growth of the organization toward its goals.

Avoiding waste is a crucial strategy in highly competitive markets, and coherence insight mapping enables organizations to quickly identify misunderstandings, resource gaps, and make a determination of the “true costs” of a new idea prior to committing to the implementation of the idea. This coherence insight mapping frees organizations from costly consultants who run around and interview multiple people and issue reports that reflect only a fraction of the embedded knowledge within the organization that could quickly and virtually be gathered by this coherence insight mapping. The coherence insight mapping also reveals opportunities for innovation because a wide array of participants are able to see what is needed from their functional unit and can coordinate efforts and initiatives to leverage existing or under-utilized resources.

In operation, the new idea, innovation or intervention is clearly described to the participants and inputted into the software. Screens are presented to the participants to lead them through this process and collect their responses. The functional units that will be involved are identified. Participants from each functional unit ask each other functional unit what they will need in order to optimize their part in the implementation. This information is shared and reviewed across the participants for systemic, diverse input and the revealing of new opportunities for collaboration. Documentation of the inputs is captured and can be further “mined” for operational improvements and leveraging of existing resources. Findings are shared among participants.

Following is an example of some aspects of coherence insight mapping.
Purpose: To construct an ideal model of a planned change that is cognisant of all the elements, activities and resources needed, identified in an exercise.
Theory: All elements in a system are dynamically connected to each other element and changes in any one element will lead to change in every other element.
Process: A coherence modeling map shows the activity sub-systems and the relationships between them as they work to achieve the optimal achievement of the system's purpose in the given environment.
   The first activity is to brainstorm all the activities necessary to achieve the purpose given the anticipated environment and the knowledge and resources under the control of the system. It is important that every activity, no matter how apparently insignificant, is captured during the brainstorming. The activities listed from the brainstorming are then collated into several (e.g., between 5 and 9) coherent clusters. In systems language, each of the clusters are labelled a sub-system (or node of the system) and the activities within the clusters, sub-sub-systems. The function of each cluster is then described in terms of its contribution to the whole performance of the system. For example, the description may be: “Coordinates use of physical resources”, “Provides information to all stakeholders”, “Evaluates quality of external criticism”. The clusters may then be represented as nodes (subsystems) in a circle.

Starting with a specific node, the dynamic relationship between each of the nodes and every other node is then discovered by asking the question “what do they need from each other to carry out their task most efficiently and effectively?”. For example, the questions can be: “What does functional unit B need from functional unit A?”, “What does C need from functional unit A?”, and so on until every possible relationship has been questioned. As a need is identified, an arrow is drawn from the node providing to the node receiving and what it is that “flows” along that arrow noted. For example, the flow note may be “authority to expend resources?”, “results of current sales campaign”, etc. Using a code and legend is a useful way of preventing the model from becoming overcrowded. The resultant model is a coherent and comprehensive approach to managing a change situation and it can be ground-truthed by using it to probe the actual situation to assess its viability in practice.

The coherence map shows the ideal flow of knowledge and resources between the activities of change program. The model identifies nodes, which will require extra resources because of the demands on them. The key areas for system failure are revealed in terms of the potential of breakdowns between various sub-activities. A systemic management process is created where the manager can focus on the relationships between activities rather than the specific activities within a node—only becoming concerned about the latter when a relationship starts to become sub-optimal. Some examples of application of the coherence mapping process may be:
building probes to test potential improvements in complex situations;
creating prototypes for innovative products and services for testing in laboratory or simulation programs;
creating knowledge management protocols where knowledge is considered to be the movement and application of information from one aspect of a business to another;
tracking supply chain flows across global markets.

### VIII/ Over-The-Horizon Insight Mapping

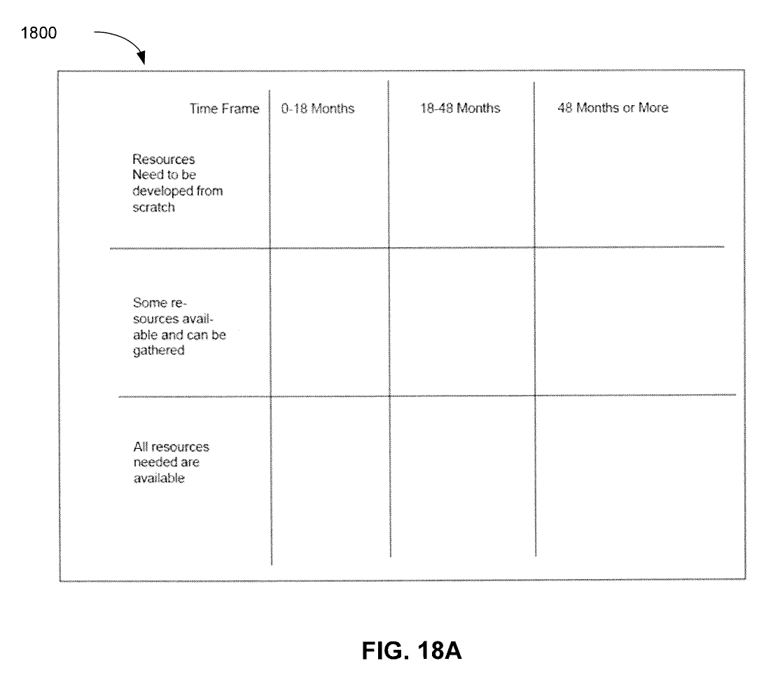

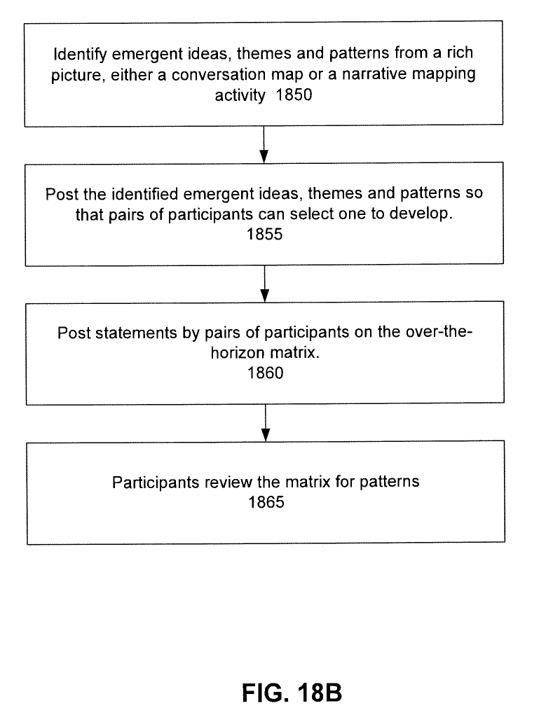

FIG. 18A illustrates an example user interface for over-the-horizon insight matrix, in accordance with some embodiments. The over-the-horizon insight mapping is documented and can then be organized on a over-the-horizon matrix 1800. This enables the entire over-the-horizon insight mapping to be arranged based on perceived resources available and time needed to implement. Patterns for “creating staircases” of coherent action can then be developed and considered for testing in the windtunneling process. They can also be tested in the coherence insight mapping for feasibility given the resources within the organization and the functional capacity. The participants can share maps with broader stakeholder groups, where appropriate, to address the coherence of these strategies within the larger mission/other strategies ongoing within the organization. The participants can build knowledge within the organization and support for new initiatives based on the insights generated from the conversation insight mapping and optional follow-on systemic methods. The over-the-horizon insight mapping creates a rich picture of a complex issue, by conversation insight mapping or learning narrative insight mapping. All of the participants engage in identifying patterns, themes, and emergent ideas.

From the conversation insight maps described above, pairs of participants may take one or more emergent idea, theme, or pattern and take it through an over-the-horizon insight mapping process, answering three questions: “What ought to be the situation relative to this idea?” What is the situation relative to this idea?” “How do we move from “is” toward “ought.?” Pairs of participants choose one of the emergent ideas from the group's output in the conversation map, and craft a “Transformation Idea Statement” of a strategy for the organization to adopt that will move the organization from “What is?” toward “What ought to be?” These statements are refined to become increasingly clear and concise, and elaborate their ideas about “What is the strategy?” “How will the strategy work?” and “Why is this important to the organization?”

The over-the-horizon insight mapping is documented as follows. The strategies are sorted by the participant-authors and organized on a over-the-horizon matrix 1800. This enables all the strategies to be displayed for all participants to review. The entire over-the-horizon insight map is arranged based on perceived resources available and time needed to implement the various strategies developed by the pairs of participants. The pairs may develop more than one strategy and post it. The visual display reveals patterns. The patterns related to staircases of coherent action can then be identified, with more complex strategies supported by developmentally preceding strategies. For example, strategy A is placed in the lower left section of the matrix 1800, which means that it can be accomplished now, and that the resources are readily available. By viewing all of the strategies posted, other participants recognize that if strategy A is implemented, it will fulfill an indispensable precondition for strategy B, which sits in the middle section of the matrix 1800. The middle section reflects that 18-48 months will be needed and resources are not readily available. Participants then notice that strategy C, which is a major organizational goal, occupies the upper right section of the matrix 1800, meaning that the resources have to be invented and it will be more than 48 months before anything can be achieved. Strategy B is a precondition and supporting set of resources for strategy C, and the appearance of a staircase from the lower left section to the upper right section is obvious for everyone. Thus, investment in A paves the way for planning and investment for B, and the ultimate ability of the organization to achieve C. More staircase patterns can be discerned, and within a short window of time, from the insights and knowledge of the participants in the room or on their screens, a coherent strategic plan can emerge with full disclosure and engagement, regardless of the complexity of the issues before the group. This coherent and comprehensive staircase is the valuable and transparent outcome of the over-the-horizon insight mapping methodology. Depending on the organizations needs and time frames, there can be various time frames and resource sections, creating diverse matrices unique to the organization's needs.

The pairs then proceed to take another emergent idea, theme, or pattern and repeat their actions, posting their work on the same matrix 1800. All of the participants study the matrix 1800 to identify patterns like staircases, TIS can lead up and to the right to another TIS, and subsequently to a major accomplishment in the upper right section. Further staircases are sought and become the basis for strategies that can be tested in the windtunneling or coherence mapping activities.

Following is an example of some aspects of over-the-horizon insight mapping.
Purpose: To explore and articulate the values, boundaries, and requisite activities in a purposeful change situation
Theory: Conceptualizing a change systemically requires these dimensions of the change system to be considered concurrently. Further, a team implementing change requires the preferred worldview and boundaries of the change to be articulated and understood to enable ongoing collaboration.
Process: The approach is a conversational one in which a group concerned with a change issue exchanges perspectives about the issue under the TIS elements. The conversation does not need to follow a linear sequence as discussion of one area may show inadequacies in earlier agreed conclusions.
   The conversation should continue until team members agree there is coherence between all the elements. The process commences through the articulation of the proposed transformation by asking three questions of the proposed change: “What is the current situation?”, “What ought to be the situation?”, and “How in this issues do we get from is to ought?” The process is assisted if time is spent thoroughly exploring the potential transformation statement, while still leaving options to change open as you proceed further. Time permitting the transformation idea can be explored further to test whether the proposed change is appropriate using questions such as:
   What is the worldview that makes this transformation of value to the organization,
   Who is (are) the owner(s) of the power in the organization who will allow or deny the change to occur?
   Who are the beneficiaries and victims of the proposed changes and in what way will they be affected?
   Who will design, implement and manage the transformation?
   Who can provide oversight and advice on unintended consequences, especially for those that are recognized elsewhere in change process?
   What are the environmental influences that can be expected to impact both positively and negatively on the change system?
   What are the activities that must be implemented to achieve the change from the current situation?

### Output

An extensively explored understanding of a managed change situation.
A holistic statement of a change suitable for posting on a over-the-horizon planning grid or other strategic planning activities
Guidance on the range of changes possible to enhance a projects performance

### Uses

Clarifying change proposals and establishing basis for stakeholder “buy in”
Exploring emergent patterns of variables offering avenues to manage complex issues
Establishing change boundaries
Exposing unintended consequences.

FIG. 18B is a flow diagram illustrating an example of an over-the-horizon insight mapping, in accordance with some embodiments. The over-the-horizon insight mapping is a process that may start at block 1850 where emergent ideas, themes and patterns are identified from a rich picture, either a conversation map or a narrative mapping activity.

At block 1855, the identified emergent ideas, themes and patterns are posted, and pairs of participants select one to develop. The pair identifies “What ought to be the situation relative to this idea?” “What is the situation currently? The pair crafts a Transformation Statement that would be a strategy that takes the organization from “What Is?” to “What ought to be?” The pair then elaborates and provides a clear and concise statement of “What is the strategy?” “How does it work?” and “Why is it important to the organization?” They refine for clarity and post on the over-the-horizon matrix, as shown in block 1860.

The matrix has been prepared by the administrator/facilitator and on the vertical axis there are 2-5 levels of resource need, and on the horizontal axis, there are 2-5 windows of time ranging from 0-12 months, 12-36 months, etc. All participants are working in parallel with different emergent ideas, themes or patterns, and generating their strategy statements and posting them on the over-the-horizon matrix. As the matrix is populated, all participants continue to take on new ideas and develop strategies, filling the matrix. All participants then review the matrix for patterns, as shown in block 1865.

The patterns that are most useful reveal investments in strategies that are immediately available for implementation, that provide a next step for a more complex strategy that requires more time and resources, and that then leads to a long-range strategic goal. This is like a staircase. Additional patterns that resemble staircases are revealed and the participants and additional leaders use these insights to build out a strategic plan, each of the strategies can be tested in the coherence insight mapping for feasibility or windtunneling for future resilience.

### X/ Integration of Techniques

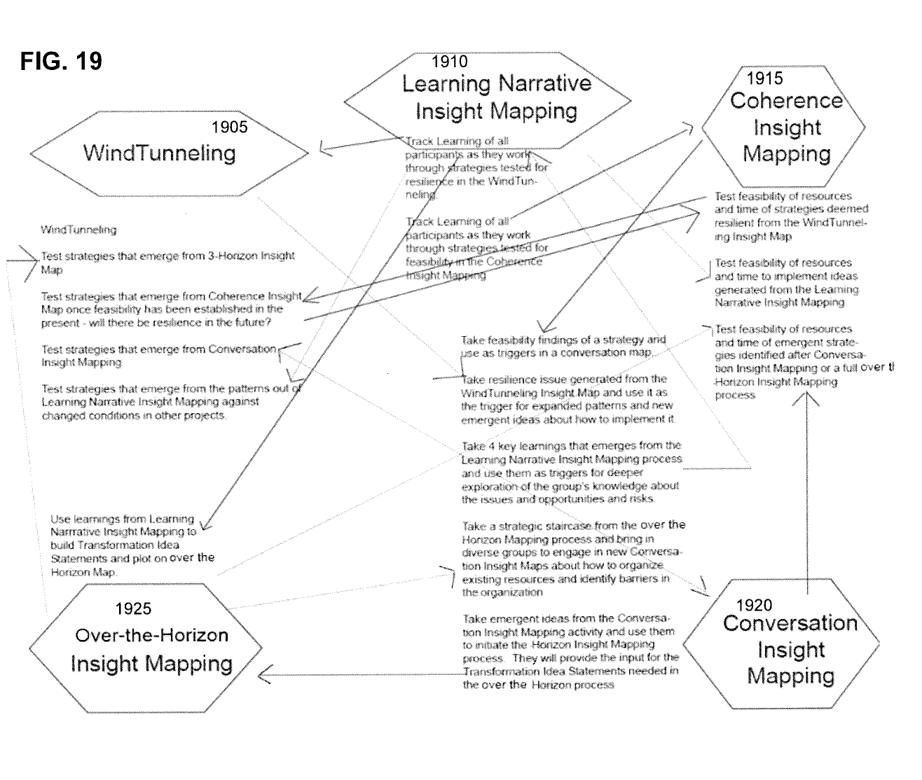

FIG. 19 illustrates an example of an integration of the various insight mappings, in accordance with some embodiments. Diagram 1900 includes windtunneling insight map component 1905, learning narrative insight mapping component 1910, coherence insight mapping component 1915, conversation insight mapping 1920, and over-the-horizon insight mapping 1925. Following are some example applications of using the components together components.

### A/ Windtunneling

Test strategies that emerge from over-the-horizon insight map
Test strategies that emerge from coherence insight map once feasibility has been established in the present—will there be resilience in the future?
Test strategies that emerge from conversation insight mapping
Test strategies that emerge from the patterns out of learning narrative insight mapping against changed conditions in other projects.

### B/ Over-The-Horizon Insight Mapping

Use learnings from learning narrative insight mapping to build transformation Idea statements and plot on three-horizon map.

### C/ Conversation Insight Mapping

Take feasibility findings of a strategy and use as triggers in a conversation map.
Take resilience issue generated from the windtunneling insight map and use it as the trigger for expanded patterns and new emergent ideas about how to implement it.
Take four key learning that emerges from the learning narrative insight mapping process and use them as triggers for deeper exploration of the group's knowledge about the issues and opportunities and risks.
Take a strategic staircase from the over-the-horizon mapping process and bring in diverse groups to engage in new conversation insight maps about how to organize existing resources and identify barriers in the organization
Take emergent ideas from the conversation insight mapping activity and use them to initiate the over-the-horizon insight mapping process. They will provide the input for the transformation idea statements needed in the over-the-horizon process

### D/ Coherence Insight Mapping

Test feasibility of resources and time of strategies deemed resilient from the windtunneling insight map
Test feasibility of resources and time to implement ideas generated from the learning narrative insight mapping
Test feasibility of resources and time of emergent strategies identified after conversation insight mapping or a full over-the-horizon insight mapping process

### E/ Learning Narrative Mapping

Track Learning of all participants as they work through strategies tested for resilience in the windtunneling.
Track Learning of all participants as they work through strategies tested for feasibility in the coherence insight mapping

### XI/ Computer Readable Media

In an embodiment, the software used to facilitate the functions and processes described herein can be embodied onto a machine-readable medium. A machine-readable medium includes any mechanism that provides (e.g., stores and/or transmits) information in a form readable by a machine (e.g., a computer). For example, a machine-readable medium includes read only memory (ROM); random access memory (RAM); magnetic disk storage media; optical storage media; flash memory devices; DVD's, EPROMs, EEPROMs, FLASH, magnetic or optical cards, or any type of media suitable for storing electronic instructions. The information representing the apparatuses and/or methods stored on the machine-readable medium may be used in the process of creating the apparatuses and/or methods described herein. Algorithms, procedures, routines, or programs as described herein in this application may also be included as variants of the anticipatory design tools.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of activities leading to a desired result. The activities are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These routines, algorithms, etc. may be written in a number of different programming languages. Also, an algorithm may be implemented with lines of code in software, configured logic gates in hardware or firmware, or a combination of both.

Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While some specific embodiments of the invention have been shown, the invention is not to be limited to these embodiments. For example, Hardware logic may be used to implement the same functions as software coding and vice versa. The invention is to be understood as not limited by the specific embodiments described herein, but only by the scope of the appended claims.

What is claimed is:

1. A computer-assisted method comprising:
enabling a diverse group of participants on one or more client machines to contribute on a user interface their thoughts based on applying two or more strategies against plausible future events, generated by the participants, to anticipate a diversity of future outcomes, wherein the thoughts contributed by the participants are stored in a database;
integrating the thoughts contributed by the participants using an application resident on one or more servers; and
displaying the integrated thoughts on displays of the participants' client machines, wherein the participants are to develop insights based on reviewing the displayed thoughts of all the participants.

2. The method of claim 1, wherein the participants contribute information related to plausible future events, and wherein the insights are used to identify one or more of risks, opportunities, and innovations associated with an occurrence of one or more such plausible future events.

3. The method of claim 1, wherein each of the participants is to rate a selected, diverse group of the plausible future events based on impacts that the plausible future events in the group are likely to have on a designated population and based on probability that each of the plausible future events in the group will occur within a given time frame, wherein the group of plausible future events including those that have high impact and high probability rating or a high standard deviation, and wherein strategies are used to test their performance against the selected plausible future events.

4. The method of claim 3, wherein each of the participants is to provide an observation and a rationale for the observation by considering how a given strategy will perform under a change condition of a plausible future event, and wherein the observation and the rationale information provided by each of the participants is stored in the one or more databases and becomes viewable to all other participants.

5. The method of claim 4, wherein the observations and rationale provided by the participants are organized into groups based on each of the strategies, and wherein successive groups of observations are reviewed by all participants to identify one or more insights from emergent ideas, patterns, or themes associated with respective groups of observations.

6. The method of claim 5, wherein the one or more insights from the emergent ideas, patterns, or themes associated with successive groups of observations is used to enable the designated population to work with a specific strategy to make the strategy more resilient to changed conditions caused by the plausible future events.

7. The method of claim 6, wherein the observations provided by the participants are organized into groups based on each of the plausible future events, and wherein the successive groups of observations are reviewed by all participants to identify one or more insights from the emergent ideas, patterns, and themes associated with the respective group of observations.

8. The method of claim 7, wherein the one or more insights from the emergent ideas, patterns, and themes associated with the respective groups of observations is used to enable the designated population to work with a specific plausible future event or an event like it, to enable the designated population to anticipate and plan for how it can optimize its position should that plausible future event, or the event like it, actually occur.

9. A computer-assisted method of enabling a diverse group of participants on one or more client machines to anonymously generate on a user interface their solicited responses about any sets of two or more independent variables that underlie a complex issue, where the sets are applied against each other, and then identify observations about the interaction coupled with their rationale, wherein an application resident on a server is configured to integrate the solicited responses from the participants forming response results and to display the response results to enable the participants to view all the response results on displays of their client machines, wherein the participants are the required to develop insights related to the complex issue based on reviewing the response results.

10. The method of claim 9, wherein the two or more sets of independent variables include a strategy variable and a future event variable, and wherein the participants are to rate each of the future events based on its impact on a designated group and based on the probability that said future event will occur within a designated window of time.

11. The method of claim 9, wherein the two or more sets of independent variables are associated within a learning environment.

12. The method of claim 9, wherein the participants are to identify observations and insights about the relevant relationships of the independent variables, comparing and contrasting their observations and insights with all other participants, wherein the participants are to be prompted to provide, using their client computers, headlines that reflect their thoughts and comments that elaborate the headlines, both of which relate to the sets of independent variable, and wherein the participants are to rate an impact that an event associated with the headline will have on a designated population and a probability that the event associated with the headline will occur, with context of impact and timeframe of occurrence being set by an administrator.

13. The method of claim 12, wherein a set of events are set for consideration by all of the participants and presented to the participants on the displays of their client machines, wherein the participants are to provide their observations about how a set of strategies will perform under their imagined changed conditions of each of the events based on own experience and background, independent of other participants, wherein the observations are stored in one or more databases and viewable by all of the other participants, each of the observations showing one participant's perspective of how the changed conditions will affect the strategy under review.

14. The method of claim 13, based on a review of all the observations of a given strategy, the participants are to generate insights to enhance the resilience of said strategy under diverse changed conditions, wherein the insights are stored into one or more databases and viewable by all of the participants.

15. The method of claim 14, based on a review of all of the observations of a given future event, the participants are to generate insights of steps to take to enhance viability of an organization should said event, or one like it, actually occur.

16. The method of claim 15, based on integrating the insights generated, administrators and the participants are to generate unique visual displays of subsets of insights relevant to specific needs of the organization.

17. An apparatus comprising:
means for enabling a group of participants to provide a first set of information to be considered;
means for enabling a group of participants to categorize the first set of information to be considered;
means for enabling the group of participants to rate impact of the first set of information on a designated population;
means for enabling the group of participants to rate probability that events associated with the first set of information will occur within a given time frame;
means for enabling the group of participants to view the first set of information and their associated ratings;
means for mapping the first set of information with a set of criteria; and
means for soliciting insights from the group of participants when applying one or more of the criteria against the first set of information.

18. The apparatus of claim 17, wherein the means for mapping the first set of information with the set of criteria comprises:
means for selecting a subset of information from the first set of information, including information related to high impact and high probability rating and high standard deviation; and
means for mapping the subset of information with the set of criteria.

19. The apparatus of claim 18, further comprising means for identifying observations and insights to enhance the resilience of each of the criteria.

20. The apparatus of claim 19, further comprising means for identifying observations and insights to build the insurance against identified risks associated with an occurrence of events associated with the subset of information.
